(19) United States
(12) Patent Application Publication
(10) Pub. No.: US 2025/0215359 A1
(43) Pub. Date: Jul. 3, 2025

(54) FABRIC CARE COMPOSITION

(71) Applicant: GIVAUDAN SA, VERNIER (CH)

(72) Inventors: Ralph GENCARELLI, East Hanover, NJ (US); Muhammad MIRZA, East Hanover, NJ (US); Sergio DI MARTINO, East Hanover, NJ (US)

(21) Appl. No.: 18/852,988

(22) PCT Filed: Mar. 20, 2023
(86) PCT No.: PCT/EP2023/056998

§ 371 Date: Sep. 30, 2024

Related U.S. Application Data
(60) Provisional application No. 63/327,141, filed on Apr. 4, 2022.

(51) Int. Cl. C11D 3/48; B01J 13/14; C11D 3/00; C11D 3/22; C11D 3/30; C11D 3/50; C11D 17/00

(52) U.S. Cl. CPC C11D 3/48; B01J 13/14; C11D 3/001; C11D 3/227; C11D 3/30; C11D 3/505; C11D 17/0039

(57) ABSTRACT

The present invention relates to a bleach-free laundry sanitizer composition comprising at least one microcapsule composition comprising a polymer encapsulating a benefit agent, wherein the benefit agent is encapsulated in core-shell microcapsules comprising a core and a shell surrounding the core.

The present invention relates to a laundry sanitizer composition, in particular to a bleach-free laundry sanitizer composition comprising encapsulated fragrance.

### BACKGROUND OF THE INVENTION

It is known to incorporate encapsulated functional materials in consumer products, such as household care, personal care and fabric care products. Functional materials include for example fragrances, cosmetic actives, and biologically active ingredients, such as biocides and drugs.

Microcapsules that are particularly suitable for delivery of such functional materials are core-shell microcapsules, wherein the core comprises the functional material and the shell is impervious or partially impervious to the functional material. Usually, these microcapsules are used in aqueous media and the encapsulated functional materials are hydrophobic. It is desirable that the shell material has no reactivity with the functional material, is inexpensive, and shows consistent properties during storage.

A broad selection of materials such as aminoplast resins, polyurea resins, polyurethane resins, polyacrylate resin, and combinations thereof have been employed for encapsulating functional materials, especially volatile functional materials, such as fragrance ingredients. Encapsulated fragrance compositions are typically prepared in the form of aqueous slurries of microcapsules. Core-shell microcapsules are relatively resistant to fragrance leakage when dispersed in aqueous suspending media, even in surfactant-containing media. However, stability and/or leakage problems arise when encapsulated perfume composition in the form of a slurry are incorporated into harsh environments, such as consumer product bases containing cationic surfactants and/or relatively acidic or basic pH, especially over a relatively long period of storage. It is also known that the stability of the polymeric shells is negatively affected by the presence of organic solvents. It is expected, therefore, that the lack of stability of the microcapsule shells is amplified when the consumer product base contains, in addition to cationic surfactants, organic solubilizing ingredients, such as alcohols and/or when the consumer product base has a pH significantly in the acidic or basic range.

Washing laundry with a laundry detergent alone at temperatures below 60 degrees C. does not kill bacteria and viruses completely. Traditionally, white laundry is sanitized with bleach. Coloured laundry, however, is not compatible with bleach and, therefore, requires use of a different chemical composition to obtain sanitization. Antibacterial laundry sanitizers which are suitable for any colour laundry have been developed, generally employing organic compounds with antiseptic properties as antibacterial agents. Such laundry sanitizers are commercialised as clear liquids, normally colourless or lightly coloured, with no fragrance or having very mild fragrance. These sanitizers are designed to be used at the rinsing stage, after the washing cycle using detergent has been completed.

When used in a washing machine, the sanitizer is added in the fabric softener compartment or poured directly into the rinse cycle, therefore dissuading the customer from using any other laundry care product which would be added in the fabric softener compartment, such as a laundry softener or a scent booster. While some laundry sanitizers may have a mild fragrance, the level of perceivable fragrance once the washing is complete is almost unnoticeable. At the same time, the unaltered smell of laundry sanitizers is a “chemical” smell, which, while not bad, is also not particularly desirable.

Nowadays, customers expect fabric care products which provide perception of the fragrance throughout the washing and rinsing cycles, at the moment the laundry is taken out of the machine, during drying and after the laundry has been dried. Such a release profile is achieved by using encapsulated fragrance components, wherein the encapsulated components contribute essentially to enhancing fragrance perception on dry fabrics. Additionally, the encapsulated components may be released during fabric handling, typically under the action of mechanical forces.

Therefore, there is a need to provide bleach-free laundry sanitizers which, at the same time as disinfecting the laundry, provides the consumer with the perception of the fragrance throughout the washing and rinsing cycles, at the moment the laundry is taken out of the machine, during drying and after the laundry has been dried.

The applicant has surprisingly and unexpectedly found that incorporating at least one microcapsule composition comprising a polymer encapsulating a benefit agent, wherein the benefit agent is encapsulated in core-shell microcapsules comprising a core and a shell surrounding the core into a bleach-free laundry sanitizer is able to satisfy both the sanitization and the fragrance perception requirement at the same time.

The “clean label” concept is one of the biggest trends of the decade. The term itself has many definitions including sustainable, naturally sourced and biodegradable ingredients as well as minimal processing and impact on the environment. Consumers are increasingly concerned about the sustainability of the products they use, however, in general, biodegradable and/or naturally sourced materials do not perform at the same level as their more established, non-biodegradable equivalents, therefore failing to meet the consumer's expectations. There is a need, therefore, to provide bleach-free laundry sanitizers comprising with a high composition of biodegradable ingredients.

### SUMMARY OF THE INVENTION

In a first aspect, the present invention provides a bleach-free laundry sanitizer composition comprising at least one microcapsule composition comprising a polymer encapsulating a benefit agent, wherein the benefit agent is encapsulated in core-shell microcapsules comprising a core and a shell surrounding the core.

In a further aspect, the invention provides a method for preparing the bleach-free laundry sanitizer composition as described herein.

The use of at least one microcapsule composition comprising a polymer encapsulating a benefit agent, wherein the benefit agent is encapsulated in core-shell microcapsules comprising a core and a shell surrounding the core to improve the perception or enhance the performance of a bleach-free laundry sanitizer composition is provided in a further aspect.

### Definitions

The term “benefit agent” refers to any substance which, when added to a product, may improve the perception of this product by a consumer or may enhance the action of this product in an application. Examples of benefit agents include perfume or fragrance ingredients, bioactive agents (such as bactericides, insect repellents and pheromones), substrate enhancers (such as silicones and brighteners), enzymes (such as lipases and proteases), dyes and pigments, and combinations thereof.

“Biodegradable” materials are defined as materials whose physical and chemical properties undergo deterioration and completely degrade when exposed to the environment. This property, therefore, relates to the end-of-life of the material. Bio-based materials can be biodegradable or non-degradable. Similarly, while many bio-based materials are biodegradable (e.g., starch), not all biodegradable materials are bio-based.

In the context of the present invention, a “biodegradable” ingredient is an ingredient which meets the pass criteria for “inherently biodegradable” and/or “readily biodegradable” in at least one OECD biodegradation study. In order to avoid any ambiguity, this means that if an ingredient passes one test but fails one or more other ones, the pass result overrules the other test results.

For assessment of the pass criteria for “readily biodegradable”, the biodegradation study can be carried out using standardised methods such as OECD Method 301C, OECD Method 301D, OECD Method 301F and OECD Method 310.

OECD Method 301C, OECD Method 301D and OECD Method 301F are described in the OECD Guidelines for the Testing of Chemicals, Section 3, Test No. 301: Ready Biodegradability (Adopted: 17 Jul. 1992; https://doi.org/10.1787/9789264070349-en).

OECD Method 310 is described in the OECD Guidelines for the Testing of Chemicals, Section 3, Test No. 310: Ready Biodegradability—CO2 in sealed vessels (Headspace Test) (Adopted: 23 Mar. 2006; Corrected: 26 Sep. 2014; https://doi.org/10.1787/9789264016316-en).

In the context of the present invention, the pass criteria for “readily biodegradable” are assessed according to OECD Method 301F, which refers to manometric respirometry. In this method the pass level for “ready biodegradability” is to reach 60% of theoretical oxygen demand and/or chemical oxygen demand. This pass value has to be reached in a 10-day window within the 28-day period of the test. The 10-day window begins when the degree of biodegradation has reached 10% of theoretical oxygen demand and/or chemical oxygen demand and must end before day 28 of the test. Given a positive result in a test of ready biodegradability, it may be assumed that the chemical will undergo rapid and ultimate biodegradation in the environment (Introduction to the OECD Guidelines for the Testing of Chemicals, Section 3, Part 1: Principles and Strategies Related to the Testing of Degradation of Organic Chemicals; Adopted: July 2003).

In the context of the present invention, all percentages refer to weight percentages (% w/w), unless otherwise indicated.

### DETAILED DESCRIPTION

Preferred and/or optional features of the invention will now be set out. Any aspect of the invention may be combined with any other aspect of the invention unless the context demands otherwise. Any of the preferred or optional features of any aspect may be combined, singly or in combination, with any aspect of the invention, as well as with any other preferred or optional features, unless the context demands otherwise.

The applicant has surprisingly and unexpectedly found that a bleach-free laundry sanitizer composition comprising at least one microcapsule composition comprising a polymer encapsulating a benefit agent, wherein the benefit agent is encapsulated in core-shell microcapsules comprising a core and a shell surrounding the core is capable of providing enhanced overall fragrance perception of the laundry sanitizer on a fabric.

The invention, therefore, provides a bleach-free laundry sanitizer composition comprising at least one microcapsule composition comprising a polymer encapsulating a benefit agent, wherein the benefit agent is encapsulated in core-shell microcapsules comprising a core and a shell surrounding the core.

### Microcapsule Composition

The microcapsules of the present invention are presented in the form core-shell microcapsules, wherein the core comprising a benefit agent is encapsulated within a shell material.

Core-shell microcapsule compositions are generally provided in the form of a slurry, that is, a dispersion or suspension of microcapsules in an aqueous medium, that may contain somewhere in the order of 60 wt.-% of water. If desired, slurries can be dried to provide microcapsule compositions in the form of a powder or cake, which generally comprises around 5 wt.-% of water.

In one embodiment, the shell of the core-shell microcapsules comprises a polymer selected from the group consisting of a melamine-formaldehyde polymer, a urea-formaldehyde polymer, a polyurea, a polyurethane, a polyamide, a polyacrylate, a polycarbonate, and mixtures thereof, as defined hereinabove.

### Thermosetting Resins

Thermosetting resins are typically obtained by reacting polyfunctional monomers, such as amines, isocyanates, alcohols or phenols, chlorocarboxylic acids, (meth)acrylates, epoxides, silanes and aldehydes.

Thermosetting resins, such as aminoplast, polyurea and polyurethane resins, as well as combinations thereof are commonly employed as shell materials in the preparation of core-shell microcapsules. They are particularly valued for their resistance to leakage of the benefit agent when dispersed in aqueous suspending media, even in surfactant-containing media.

In one embodiment, the shell may comprise a melamine-formaldehyde polymer. This type of core-shell capsule has proved to be particularly suitable for benefit agent encapsulation and is described, for instance in WO 2018/197266 A1, WO 2016/207180 A1, and WO 2017/001672 A1.

In one embodiment, the shell may comprise a polyurea or polyurethane polymer. Also this type of core-shell capsule has been successfully used for benefit agent encapsulation and has the advantage to address consumer concerns with regard to residual formaldehyde in the composition. Such capsules are also described, for instance in WO 2016/071149 A1.

In one embodiment, the shell may comprise, a polyacrylate, one or more monoethylenically unsaturated and/or polyethylenically unsaturated monomer(s) in polymerized form. This type of core-shell capsule has also been successfully used for benefit agent encapsulation. Such capsules are described in the prior art, for instance in WO 2013/111912 A1 or WO 2014/032920 A1.

### Polymeric Stabilizer

In one embodiment, the shell may comprise a polymeric stabilizer that is formed by combination of a polymeric surfactant with at least one aminosilane. The polymeric surfactant comprises a polysaccharide comprising carboxylic acid groups. The aminosilane is as defined hereinbelow. The shell may further comprise a polysaccharide, preferably a polysaccharide comprising beta (1→4) linked monosaccharide units, even more preferably a cellulose derivative, in particular selected form the group consisting of hydroxyethyl cellulose, hydroxypropylmethyl cellulose, cellulose acetate, carboxymethyl cellulose, and combinations thereof, preferably hydroxyethyl cellulose. Such capsules are described in the prior art, for instance in WO 2020/233887A1.

### Hydrated Polymer Phase and Polymeric Stabilizer

In one embodiment, the shell may comprise a hydrated polymer phase and a polymeric stabilizer at an interface between the shell and the core.

In such an arrangement, the polymeric stabilizer provides an impervious encapsulating material, whereas the hydrated polymer phase provides the desired deposition and adherence to the substrate. Furthermore, without being bound by any theory, it is surmised that the hydrated polymer phase also provides an optimal point of attack for microbial degradation.

The polymeric stabilizer may be selected from a broad range of film-forming materials and resins. Preferably, the polymeric stabilizer is highly cross-linked, in order to decrease significantly the diffusion of the encapsulated benefit agent through the shell. Preferably the imperviousness of the shell is sufficiently high to significantly prevent the leakage of the benefit agent in extractive base, such as consumer products comprising surfactants.

In one embodiment of the present invention, the polymeric stabilizer is a thermosetting resin.

Thermosetting resins are typically obtained by reacting polyfunctional monomers, such as amines, isocyanates, alcohols or phenols, chlorocarboxylic acids, (meth)acrylates, epoxides, silanes and aldehydes.

In one embodiment of the present invention, the polymeric stabilizer is formed by reaction of an aminosilane with a polyfunctional isocyanate. Such a polymeric stabilizer has the advantage of being highly crosslinked and susceptible of providing surface anchoring groups that can be used to immobilize additional materials to complete shell formation. These additional materials may comprise additional encapsulating materials, coatings and, as described in more details hereinafter, simple and complex coacervate, and hydrogels.

The aminosilane employed in the formation of the polymeric stabilizer can be selected from a compound of Formula (I).

Si(R¹)(R²)_{f}(OR³)_{(3-f)} Formula (I)

wherein R¹ is a linear or branched alkyl or alkenyl residue comprising an amine functional group; R² is each independently a linear or branched alkyl group with 1 to 4 carbon atoms; R³ is each independently a H or a linear or branched alkyl group with 1 to 4 carbon atoms; and f is 0, 1 or 2.

The silane groups may undergo polycondensation reactions with one another to form a silica network at the oil/water interface that additionally stabilizes this interface.

In one embodiment, R² and R³ are each independently methyl or ethyl.

In one embodiment, f is 0 or 1.

In one embodiment, R¹ is a C₁-C₁₂ linear or branched alkyl or alkenyl residue comprising an amine functional group. Optionally, R¹ is a C₁-C₄ linear or branched alkyl or alkenyl residue comprising an amine functional group.

In one embodiment, the amine functional group is a primary, a secondary or a tertiary amine.

In one embodiment, the at least one aminosilane is a bipodal aminosilane. By “bipodal aminosilane” it is meant a molecule comprising at least one amino group and two residues, each of these residues bearing at least one alkoxysilane moiety. Bipodal aminosilanes are particularly advantageous for forming stable oil-water interfaces, compared to conventional aminosilanes. Without wishing to be bound by theory, it is believed that this beneficial role is due to the particular, bi-directional arrangement of the silane moieties in the molecule of a bipodal aminosilane, which allows formation of a more tightly linked silica network at the oil-water interface.

In one embodiment, the bipodal aminosilane is a compound of Formula (II).

(O—R³)_{(3-f)}(R²)_{f}Si—R⁴—X—R⁴—Si(O—R³)_{(3-f)}(R²)_{f} Formula (II)

wherein X is —NR⁵—, —NR⁵—CH₂—NR⁵—, —NR⁵—CH₂—CH₂—NR⁵—, —NR⁵—CO—NR⁵—, or

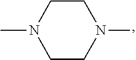

R² is each independently a linear or branched alkyl group with 1 to 4 carbon atoms;
R³ is each independently H or a linear or branched alkyl group with 1 to 4 carbon atoms;
R⁴ is each independently a linear or branched alkylene group with 1 to 6 carbon atoms;
R⁵ is each independently H, CH₃ or C₂H₅; and
f is each independently 0, 1 or 2.

In one embodiment, R² is CH₃ or C₂H₅.

In one embodiment, R³ is CH₃ or C₂H₅.

In one embodiment, R⁴ is —CH₂—, —CH₂—CH₂— or —CH₂—CH₂—CH₂—.

In one embodiment, R⁵ is H or CH₃.

In one embodiment, f is 0 or 1.

Examples of suitable bipodal aminosilanes include, but are not limited to, bis(3-(triethoxysilyl)propyl)amine, N,N′-bis(3-(trimethoxysilyl)propyl)urea, bis(3-(methyldiethoxysilyl)propyl)amine, N,N′-bis(3-(trimethoxysilyl)propyl)ethane-1,2-diamine, bis(3-(methyldimethoxysilyl)propyl)-N-methylamine, N,N′-bis(3-(triethoxysilyl)propyl)piperazine, and combinations thereof.

In one embodiment, the bipodal aminosilane is bis(3-(triethoxysilyl)propyl)amine, which has the advantage of releasing ethanol instead of more toxic and less desirable methanol during the polycondensation of the ethoxysilane groups.

The bipodal aminosilane can be a secondary aminosilane. Using a secondary bipodal aminosilane instead of a primary aminosilane decreases the reactivity of the polymeric stabilizer with respect to electrophilic species, in particular aldehydes. Hence, benefit agents containing high levels of aldehydes may be encapsulated with a lower propensity for adverse interactions between core-forming and shell-forming materials.

Other aminosilanes may also be used in combination with the aforementioned bipodal aminosilanes, in particular the aminosilanes described hereinabove.

The polyfunctional isocyanate may be selected from organic isocyanates, in which an isocyanate group is bonded to an organic residue (R—N═C═O or R—NCO). The polyfunctional isocyanate may be selected from alkyl, alicyclic, aromatic and alkylaromatic, as well as anionically modified polyfunctional isocyanates, with two or more (e.g. 3, 4, 5, etc.) isocyanate groups in a molecule, and mixtures thereof.

Preferably, the polyfunctional isocyanate is an aromatic or an alkylaromatic isocyanate, the alkylaromatic polyfunctional isocyanate having preferably methylisocyanate groups attached to an aromatic ring. Both aromatic and methylisocyanate-substituted aromatic polyfunctional isocyanates have a superior reactivity compared to alkyl and alicyclic polyfunctional isocyanates. Among these, 2-ethylpropane-1,2,3-triyl tris((3-(isocyanatomethyl)phenyl)carbamate) is particularly preferred, because of its trifunctional nature that favors the formation of intermolecular cross-links and because of its intermediate reactivity that favors network homogeneity. This alkylaromatic polyfunctional isocyanate is commercially available under the trademark Takenate D-100 N, sold by Mitsui or under the trademark Desmodur® Quix175, sold by Covestro.

As an alternative to aromatic or alkylaromatic polyfunctional isocyanates, it may also be advantageous to add an anionically modified polyfunctional isocyanates, because of the ability of such polyfunctional isocyanates to react at the oil/water interface and even in the water phase close to the oil/water interface. A particularly suitable anionically modified polyfunctional isocyanate has Formula (III).

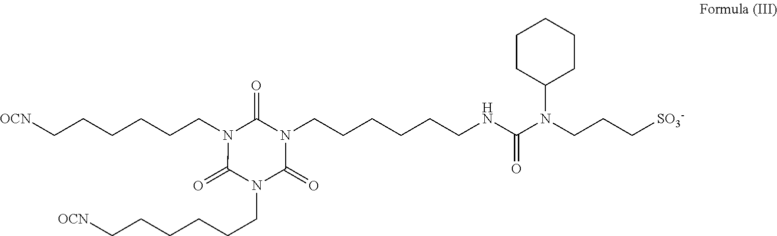

Formula (III) shows a commercially available anionically modified polyisocyanate, which is a modified isocyanurate of hexamethylene diisocyanate, sold by Covestro under the trademark Bayhydur® XP2547.

In a preferred embodiment of the present invention, polyfunctional isocyanate is 2-ethylpropane-1,2,3-triyl tris((3-(isocyanatomethyl)phenyl)carbamate). Particularly preferably, the polymeric stabilizer is formed by reaction of bis(3-(triethoxysilyl)propyl)amine and 2-ethylpropane-1,2,3-triyl tris((3-(isocyanatomethyl)phenyl)carbamate). The combination of this particular bipodal secondary aminosilane and polyfunctional isocyanate provides advantageous interface stability and release properties. The stabilized interface is sufficiently impervious to effectively encapsulate the at least one benefit agent comprised in the core and possesses the desired surface functional groups.

In preferred embodiments of the present invention the hydrated polymer phase can be a coacervate, in particular a complex coacervate.

By “complex coacervation” is meant the formation of an interfacial layer comprising a mixture of polyelectrolytes.

The phenomenon of coacervation may be observed under a light microscope, wherein it is marked by the appearance of a ring around the core composition droplet. This ring consists of the aforementioned polyelectrolyte-rich phase that has a different refractive index than the surrounding aqueous phase.

The coacervation of a polyelectrolyte is generally induced by bringing the polyelectrolyte to its isoelectric point, meaning the point where the net charge of the polyelectrolyte is zero or close to zero. This may be achieved by changing the salt concentration or the pH of the medium. In a complex coacervation, complexation occurs at the pH where one of the polyelectrolytes has an overall positive electrical charge (polycation), whereas the other polyelectrolyte has an overall negative charge (polyanion), so that the overall electrical charge of the complex is neutral.

In preferred embodiments of the present invention, the coacervate may be formed from a polycation and a polyanion.

Preferably, the pH is used as parameter driving the coacervation. Thus, the polycation preferably has a pH-dependent electrical charge. This is the case for polymers bearing primary, secondary and tertiary amino groups, such as polyamines, for example chitosan, and most proteins, for example gelatin. Proteins have the additional advantage of being prone to temperature-dependent structural transitions that may also be used to control the morphology of the coacervates. In particular, varying the temperature of some proteins may induce the formation of secondary, tertiary or quaternary structures of the protein that may also be used to control the properties of the coacervate.

Chitosan has the advantage of being derived from chitin, which is a natural polymer.

In preferred embodiments of the present invention, the polycation is selected from the group consisting of proteins, chitosan, and combinations thereof.

More particularly, the polycation can be a protein selected from the group consisting of gelatin, casein, albumin, polylysine, soy proteins, pea proteins, rice proteins, hemp proteins, and combinations thereof.

In particularly preferred embodiments of the present invention, the at least one protein is a gelatin, even more preferably a Type B gelatin.

Type B gelatin can be obtained from the alkaline treatment of collagen and is well known for its ability to form complexes with anionic polyelectrolytes, such as negatively charged polysaccharides under mild acidic conditions.

Gelatin is usually characterized by the so-called “Bloom Strength”. In the context of the present invention, the Bloom Strength refers to the rigidity of a gelatin film, as measured by so-called “Bloom Gelometer”, according to the Official Procedures of the Gelatin Manufacturers Institute of America, Inc., revised 2019, Chapter 2.1. According to this procedure, the Bloom Strength, expressed in Bloom, is equal to the weight, expressed in g, required to move vertically a standardized plunger, having a diameter of 12.5 mm, to a depth of 4 mm into a gelatin gel, which has been prepared under controlled conditions, i.e. by dissolving 6.67 wt.-% of gelatin in deionized water at 60° C., in a standardized jar, and letting the gel form for 17 hours at 10° C. The higher the weight is, the higher is the Bloom Strength of the gelatin used for making the tested gel.

In preferred embodiments of the present invention, the Type B gelatin has a Bloom Strength of 90 to 250 Bloom.

If the Bloom Strength is too low, the gel is mechanically weak and coacervates obtained therefrom may not form a self-standing layer of gelatin-rich phase around the core composition. If the Bloom Strength is too high, then the coacervates and the gelatin-rich phase obtained therefrom may be too brittle.

In preferred embodiments of the present invention, the Type B gelatin is obtainable from fish, because fish gelatin meets better acceptance within consumer than beef or pork gelatin, mainly due to health concerns, sociological context or religious rules.

Alternatively, the protein may be a vegetable protein, in particular a pea protein and/or a soy protein, which have the advantage of being vegan.

The polycation may be a denaturated protein. In the contrary to native proteins, denaturated proteins have been deprived from their ability to form secondary, tertiary or quaternary structures and are essentially amorphous. Such amorphous proteins may form more impervious films compared to native proteins and therefore also contribute to the encapsulating power of the shell. Denaturation may be achieved by treating the protein with chemical or physical means, such as acid or alkaline treatment, heat or exposure to hydrogen bond disrupting agents.

In cases where the polycation is chitosan, the chitosan can have a molecular weight between 3′000 and 1′000′000 g/mol, more particularly between 10′000 and 500′000 g/mol, still more particularly between 30′000 and 300′000 g/mol.

The polyanion may be any negatively charged polymer. However, as the pH is preferably used to control coacervation, it may be more advantageous that the electrical charge of the polymer is pH-dependent. Such polymer may be selected from polymers having pendent carboxylic groups, such as methacrylic acid and acrylic acid polymers and copolymers, hydrolyzed maleic anhydride copolymers and polysaccharides bearing carboxylic groups.

In preferred embodiments of the present invention, the polyanion is a polysaccharide comprising carboxylate groups and/or sulfate groups.

Polysaccharides comprising carboxylate groups are particularly suitable for complex coacervation with proteins. This is due to the fact that the net electrical charge of these polysaccharides may be adjusted by adjusting the pH, so that the complexation with ampholytic proteins is facilitated. Complexation occurs at the pH where the protein has an overall positive electrical charge, whereas the polysaccharide as an overall negative charge, so that the overall electrical charge of the complex is neutral. These polysaccharides include native polysaccharides, i.e. unmodified from nature, and modified polysaccharides.

The polysaccharide comprising carboxylic acid groups may comprise uronic acid units, in particular hexuronic acid units. Such polysaccharides are broadly available in nature.

The hexuronic acid units can be selected from the group consisting of galacturonic acid units, glucuronic acid units, in particular 4-O-methyl-glucuronic acid units, guluronic acid units, mannuronic acid units, and combinations thereof.

The polysaccharide comprising carboxylic acid groups may be branched. Branched polysaccharides comprising carboxylic acid groups have the advantage of forming more compact networks than linear polysaccharides and therefore may favor the imperviousness of the encapsulating shell, resulting in reduced leakage and greater encapsulation efficiency.

The carboxylate groups can be at least partially present in the form of the corresponding carboxylate salt, in particular the corresponding sodium, potassium, magnesium or calcium carboxylate salt.

In particular embodiments of the present invention, the polyanion is selected from the group consisting of pectin, gum arabic, alginate, and combinations thereof.

Among the pectins, the carboxylic acid groups can be partially present in the form of the corresponding methyl ester. The percentage of carboxylic acid groups that are present in the form of the corresponding methyl ester can be from 3% to 95%, preferably from 4% to 75%, more preferably from 5 to 50%. Pectins comprising carboxylic groups, of which 50% or more are present in the form of the corresponding methyl ester, are referred to as “high methoxylated”. Pectins comprising carboxylic acid groups, of which less than 50% are present in the form of the corresponding methyl ester, are referred to as “low methoxylated”.

Among the two variants of gum Arabic, i.e. gum acacia Senegal and gum acacia Seyal, gum acacia Senegal is preferred, owing to the higher level of glucuronic acid in gum acacia Senegal.

The hydrated polymer phase can be a hydrogel.

In context of the present invention, a “hydrogel” is a three-dimensional (3D) network of hydrophilic polymers that can swell in water, while maintaining the structure due to chemical or physical cross-linking of individual polymer chains.

Such a hydrogel can be formed by several methods at interfaces, especially by self-assembly of polyelectrolytes around existing interfaces, covalent grafting of pre-formed hydrogel particles in solution, polymerization of hydrosoluble monomers initiated at the interface and phase separation of water soluble macromolecules onto the interface.

To avoid any ambiguity, in context of the present invention, a coacervate, especially a complex coacervate, which is cross-liked, in particular by covalent bonds, is considered as a hydrogel.

The applicant has found that the use of hydrogels particularly enhances both the deposition and adherence of microcapsules on substrates, in particular on fabrics.

The hydrogel can be interlinked with the polymeric stabilizer, in particular via the functional groups present on the surface of this stabilizer.

This allows the locking of the hydrogel layer onto the polymeric stabilizer present at droplet interface, making the shell composed of a polymer composite, instead of only a blend.

Both hydrogel cross-linking and hydrogel interlinking with the polymeric stabilizer may be performed sequentially or simultaneously.

In preferred embodiments of the present invention, the hydrogel is a crosslinked coacervate, in particular a complex coacervate crosslinked with polyfunctional aldehyde, more particularly a difunctional aldehyde selected from the group consisting of succinaldehyde, glutaraldehyde, glyoxal, benzene-1,2-dialdehyde, benzene-1,3-dialdehyde, benzene-1,4-dialdehyde, piperazine-N,N-dialdehyde, 2,2′-bipyridyl-5,5′-dialdehyde, and combinations thereof. Difunctional aldehydes are known to be effective cross-linking agents for proteins.

The hydrogel can be thermosensitive and possess a gelation temperature, in particular between 20° C. and 50° C., preferably between 25° C. and 40° C. When using such a hydrogel, the deposition performance of the capsules on fabic can increase, when washing the fabric at a temperature which is above hydrogel gelation temperature.

The shell can be further stabilized with a stabilizing agent. Preferably the stabilizing agent comprises at least two carboxylic acid groups. Even more preferably, the stabilizing agent is selected from the group consisting of citric acid, benzene-1,3,5-tricarboxylic acid, benzene-1,2,4-tricarboxylic acid, 2,5-furandicarboxylic acid, itaconic acid, poly(itaconic acid) and combinations thereof.

### Coacervates

In one embodiment, the shell can comprise a complex coacervate formed of at least one protein and at least one polysaccharide. Such core-shell capsules have proved suitable for benefit agent encapsulation and are described, for instance in WO 1996/020612 A1, WO 2001/03825 A1 or WO 2015/150370 A1.

Cross-linking of at least one protein with a first cross-linking agent followed by the addition of at least one polysaccharide to form a complex coacervate is described in WO 2021/239742 A1.

In one embodiment, the shell of the microcapsules is as described in WO 2023/020883 A1.

In one embodiment, the shell of the microcapsules can be made of a biodegradable material or a non-biodegradable material. In one embodiment, the microcapsules are made of a biodegradable material.

In preferred embodiments of the present invention, the volume median diameter Dv(50) of the plurality of core-shell microcapsules is from 1 to 100 μm, preferably 5 to 75 μm, more preferably 8 to 60 μm, even more preferably 10 to 30 μm. Microcapsules having volume median diameter in the range from 10 to 30 μm show optimal deposition on various substrates, such as fabrics and hair.

The resultant encapsulated composition, presented in the form of a slurry of microcapsules suspended in an aqueous suspending medium, may be incorporated as such in a consumer product base. If desired, however, the slurry may be dried to present the encapsulated composition in dry powder form. Drying of a slurry of microcapsules is conventional, and may be carried out according techniques known in the art, such as spray-drying, evaporation, lyophilization or use of a desiccant. Typically, as is conventional in the art, dried microcapsules will be dispersed or suspended in a suitable powder, such as powdered silica, which can act as a bulking agent or flow aid. Such suitable powder may be added to the encapsulated composition before, during or after the drying step.

In particular, the drying process may be accompanied by an additional encapsulation process, wherein an additional functional material is entrapped in an additional encapsulating material. For example, the slurry to be dried may comprise, additionally to the core-shell microcapsules obtained in the process according to the present invention, at least one non-encapsulated functional material and at least one water-soluble encapsulating material, so that the functional material, that is not encapsulated in the core-shell microcapsule, is entrapped in the water-soluble encapsulating material during drying. Typically, the at least one water-soluble encapsulating material comprises at least one hydrocolloid, such as starch octenyl succinate and gum acacia. The hydrocolloid promotes and stabilizes the dispersion of the non-encapsulated material in the aqueous phase of the slurry, so that, upon drying, a matrix is formed around or coexisting with the core-shell microcapsules.

The functional material that is encapsulated in the core-shell microcapsules may comprise a first fragrance, whereas the functional material entrapped in the water-soluble encapsulating material may comprise a second fragrance, wherein the first and second fragrances are identical or different.

Combining at least two encapsulation processes has the advantage of providing different mechanisms for releasing the functional material, for example a combination of moisture-induced and mechanical stress-induced releases.

The drying step may also be accompanied or followed by mechanical or thermal treatment, such as spheronization, granulation and extrusion.

In a microcapsule composition according to the present invention, the proportion of the benefit agent can be between about 10 to about 50 wt.-%, preferably between about 20 to about 47.5 wt.-%, even more preferably between about 30 to about 45 wt.-%, relative to the total weight of the microcapsule composition.

The proportion of the microcapsule composition as described herein above may be between about 1 wt.-% to about 30 wt.-%, preferably between about 1.5 wt.-% to about 20 wt.-%, more preferably between about 2 wt.-% to about 10 wt.-%, relative to the total weight of the solid composition.

### Benefit Agent

The benefit agent comprised in the core can be selected from the group consisting of fragrance ingredients, bioactive agents, substrate enhancers, enzymes, dyes and pigments, and combinations thereof.

In particular embodiments of the present invention, the core comprises at least one fragrance ingredient. A comprehensive list of fragrance ingredients that may be encapsulated in accordance with the present invention may be found in the perfumery literature, for example “Perfume & Flavor Chemicals”, S. Arctander (Allured Publishing, 1994). Encapsulated perfumes according to the present invention preferably comprise fragrance ingredients selected from the group consisting of ACETYL ISOEUGENOL ((E)-2-methoxy-4-(prop-1-en-1-yl)phenyl acetate); ADOXAL (2,6,10-trimethylundec-9-enal); AGRUMEX (2-(tert-butyl)cyclohexyl acetate); ALDEHYDE C 10 DECYLIC (decanal); ALDEHYDE C 11 MOA (2-methyldecanal); ALDEHYDE C 11 UNDECYLENIC (undec-10-enal); ALDEHYDE C 110 UNDECYLIC (undecanal); ALDEHYDE C 12 LAURIC (dodecanal); ALDEHYDE C 12 MNA PURE (2-methylundecanal); ALDEHYDE C 8 OCTYLIC (octanal); ALDEHYDE C 9 ISONONYLIC (3,5,5-trimethylhexanal); ALDEHYDE C 9 NONYLIC FOOD GRADE (nonanal); ALDEHYDE C 90 NONENYLIC ((E)-non-2-enal); ALDEHYDE ISO C 11 ((E)-undec-9-enal); ALDEHYDE MANDARINE ((E)-dodec-2-enal); ALLYL AMYL GLYCOLATE (prop-2-enyl 2-(3-methylbutoxy)acetate); ALLYL CAPROATE (prop-2-enyl hexanoate); ALLYL CYCLOHEXYL PROPIONATE (prop-2-enyl 3-cyclohexylpropanoate); ALLYL OENANTHATE (prop-2-enyl heptanoate); AMBER CORE1-((2-(tert-butyl)cyclohexyl)oxy)butan-2-ol AMBERKETAL (3,8,8,11a-tetramethyldodecahydro-1H-3,5a-epoxynaphtho[2,1-c]oxepine); AMBERMAX (1,3,4,5,6,7-hexahydro-.beta.,1,1,5,5-pentamethyl-2H-2,4a-Methanonaphthalene-8-ethanol); AMBRETTOLIDE ((Z)-oxacycloheptadec-10-en-2-one); AMBROFIX ((3aR,5aS,9aS,9bR)-3a,6,6,9a-tetramethyl-2,4,5,5a,7,8,9,9b-octahydro-1H-benzo[e][1]benzofuran); AMYL BUTYRATE (pentyl butanoate); AMYL CINNAMIC ALDEHYDE ((Z)-2-benzylideneheptanal); AMYL SALICYLATE (pentyl 2-hydroxybenzoate); ANETHOLE SYNTHETIC ((E)-1-methoxy-4-(prop-1-en-1-yl)benzene); ANISYL ACETATE (4-methoxybenzyl acetate); APHERMATE (1-(3,3-dimethylcyclohexyl)ethyl formate); AUBEPINE PARA CRESOL (4-methoxybenzaldehyde); AURANTIOL ((E)-methyl 2-((7-hydroxy-3,7-dimethyloctylidene)amino)benzoate); BELAMBRE ((1R,2S,4R)-2′-isopropyl-1,7,7-trimethylspiro[bicyclo[2.2.1]heptane-2,4′-[1,3]dioxane]); BENZALDEHYDE (benzaldehyde); BENZYL ACETATE (benzyl acetate); BENZYL ACETONE (4-phenylbutan-2-one); BENZYL BENZOATE (benzyl benzoate);; BENZYL SALICYLATE (benzyl 2-hydroxybenzoate); BERRYFLOR (ethyl 6-acetoxyhexanoate); BICYCLO NONALACTONE (octahydro-2H-chromen-2-one); BOISAMBRENE FORTE ((ethoxymethoxy)cyclododecane); BOISIRIS ((1S,2R,5R)-2-ethoxy-2,6,6-trimethyl-9-methylenebicyclo[3.3.1]nonane); BORNEOL CRYSTALS ((1S,2S,4S)-1,7,7-trimethylbicyclo[2.2.1]heptan-2-ol); BORNYL ACETATE ((2S,4S)-1,7,7-trimethylbicyclo[2.2.1]heptan-2-yl acetate); BOURGEONAL (3-(4-(tert-butyl)phenyl)propanal); BUTYL BUTYRO LACTATE (1-butoxy-1-oxopropan-2-yl butanoate); BUTYL CYCLOHEXYL ACETATE PARA (4-(tert-butyl)cyclohexyl acetate); BUTYL QUINOLINE SECONDARY (2-(2-methylpropyl)quinoline); CAMPHOR SYNTHETIC ((1S,4S)-1,7,7-trimethylbicyclo[2.2.1]heptan-2-one); CARVACROL (5-isopropyl-2-methylphenol); CARVONE LAEVO ((5R)-2-methyl-5-prop-1-en-2-ylcyclohex-2-en-1-one); CASHMERAN (1,1,2,3,3-pentamethyl-2,3,6,7-tetrahydro-1H-inden-4(5H)-one); CASSYRANE (5-tert-butyl-2-methyl-5-propyl-2H-furan); CEDRENE ((1S,8aR)-1,4,4,6-tetramethyl-2,3,3a,4,5,8-hexahydro-1H-5,8a-methanoazulene); CEDRYL ACETATE ((1S,6R,8aR)-1,4,4,6-tetramethyloctahydro-1H-5,8a-methanoazulen-6-yl acetate); CEDRYL METHYL ETHER ((1R,6S,8aS)-6-methoxy-1,4,4,6-tetramethyloctahydro-1H-5,8a-methanoazulene); CETONE V ((E)-1-(2,6,6-trimethylcyclohex-2-en-1-yl)hepta-1,6-dien-3-one); CINNAMIC ALCOHOL SYNTHETIC ((E)-3-phenylprop-2-en-1-ol); CINNAMIC ALDEHYDE ((2E)-3-phenylprop-2-enal); CINNAMYL ACETATE ((E)-3-phenylprop-2-en-1-yl acetate); CIS JASMONE ((Z)-3-methyl-2-(pent-2-en-1-yl)cyclopent-2-enone); CIS-3-HEXENOL ((Z)-hex-3-en-1-ol); CITRAL TECH ((E)-3,7-dimethylocta-2,6-dienal); CITRATHAL R ((Z)-1,1-diethoxy-3,7-dimethylocta-2,6-diene); CITRONELLAL (3,7-dimethyloct-6-enal); CITRONELLOL EXTRA (3,7-dimethyloct-6-en-1-ol); CITRONELLYL ACETATE (3,7-dimethyloct-6-en-1-yl acetate); CITRONELLYL FORMATE (3,7-dimethyloct-6-en-1-yl formate); CITRONELLYL NITRILE (3,7-dimethyloct-6-enenitrile); CLONAL (dodecanenitrile); CORANOL (4-cyclohexyl-2-methylbutan-2-ol); COSMONE ((Z)-3-methylcyclotetradec-5-enone); COUMARIN PURE CRYSTALS (2H-chromen-2-one); CRESYL ACETATE PARA ((4-methylphenyl) acetate); CRESYL METHYL ETHER PARA (1-methoxy-4-methylbenzene); CUMIN NITRILE (4-isopropylbenzonitrile); CYCLAL C (2,4-dimethylcyclohex-3-ene-1-carbaldehyde); CYCLAMEN ALDEHYDE EXTRA (3-(4-isopropylphenyl)-2-methylpropanal); CYCLOGALBANATE (allyl 2-(cyclohexyloxy)acetate); CYCLOHEXYL ETHYL ACETATE (2-cyclohexylethyl acetate); CYCLOHEXYL SALICYLATE (cyclohexyl 2-hydroxybenzoate); CYCLOMYRAL (8,8-dimethyl-1,2,3,4,5,6,7,8-octahydronaphthalene-2-carbaldehyde); CYMENE PARA (1-methyl-4-propan-2-ylbenzene); DAMASCENONE ((E)-1-(2,6,6-trimethylcyclohexa-1,3-dien-1-yl)but-2-en-1-one); DAMASCONE ALPHA ((E)-1-(2,6,6-trimethylcyclohex-2-en-1-yl)but-2-en-1-one); DAMASCONE DELTA (1-(2,6,6-trimethyl-1-cyclohex-3-enyl)but-2-en-1-one); DECALACTONE GAMMA (5-hexyloxolan-2-one); DECENAL-4-TRANS ((E)-dec-4-enal); DELPHONE (2-pentylcyclopentanone); DELTA-3 CARENE ((1S,6S)-3,7,7-trimethylbicyclo[4.1.0]hept-3-ene); DIHEXYL FUMARATE (dihexyl-but-2-enedioate); DIHYDRO ANETHOLE (1-methoxy-4-propylbenzene); DIHYDRO JASMONE (3-methyl-2-pentylcyclopent-2-enone); DIHYDRO MYRCENOL (2,6-dimethyloct-7-en-2-ol); DIMETHYL ANTHRANILATE (methyl 2-(methylamino)benzoate); DIMETHYL BENZYL CARBINOL (2-methyl-1-phenylpropan-2-ol); DIMETHYL BENZYL CARBINYL ACETATE (2-methyl-1-phenylpropan-2-yl acetate); DIMETHYL BENZYL CARBINYL BUTYRATE (2-methyl-1-phenylpropan-2-yl butanoate); DIMETHYL OCTENONE (4,7-dimethyloct-6-en-3-one); DIMETOL (2,6-dimethylheptan-2-ol); DIPENTENE (1-methyl-4-(prop-1-en-2-yl)cyclohex-1-ene); DIPHENYL OXIDE (oxydibenzene); DODECALACTONE DELTA (6-heptyltetrahydro-2H-pyran-2-one); DODECALACTONE GAMMA (5-octyloxolan-2-one); DODECENAL ((E)-dodec-2-enal); DUPICAL ((E)-4-((3aS,7aS)-hexahydro-1H-4,7-methanoinden-5(6H)-ylidene)butanal); EBANOL ((E)-3-methyl-5-(2,2,3-trimethylcyclopent-3-en-1-yl)pent-4-en-2-ol); ESTERLY (ethyl cyclohexyl carboxylate); ETHYL ACETATE (ethyl acetate); ETHYL ACETOACETATE (ethyl 3-oxobutanoate); ETHYL CINNAMATE (ethyl 3-phenylprop-2-enoate); ETHYL HEXANOATE (ethyl hexanoate); ETHYL LINALOOL ((E)-3,7-dimethylnona-1,6-dien-3-ol); ETHYL LINALYL ACETATE ((Z)-3,7-dimethylnona-1,6-dien-3-yl acetate); ETHYL MALTOL (2-ethyl-3-hydroxy-4H-pyran-4-one); ETHYL METHYL-2-BUTYRATE (ethyl 2-methylbutanoate); ETHYL OCTANOATE (ethyl octanoate); ETHYL OENANTHATE (ethyl heptanoate); ETHYL PHENYL GLYCIDATE (ethyl 3-phenyloxirane-2-carboxylate); ETHYL SAFRANATE (ethyl 2,6,6-trimethylcyclohexa-1,3-diene-1-carboxylate); ETHYL VANILLIN (3-ethoxy-4-hydroxybenzaldehyde); ETHYLENE BRASSYLATE (1,4-dioxacycloheptadecane-5,17-dione); EUCALYPTOL ((1s,4s)-1,3,3-trimethyl-2-oxabicyclo[2.2.2]octane); EUGENOL (4-allyl-2-methoxyphenol); EVERNYL (methyl 2,4-dihydroxy-3,6-dimethylbenzoate); FENCHYL ACETATE ((2S)-1,3,3-trimethylbicyclo[2.2.1]heptan-2-yl acetate); FENCHYL ALCOHOL ((1S,2R,4R)-1,3,3-trimethylbicyclo[2.2.1]heptan-2-ol); FENNALDEHYDE (3-(4-methoxyphenyl)-2-methylpropanal); FIXAMBRENE (3a,6,6,9a-tetramethyldodecahydronaphtho[2,1-b]furan); FIXOLIDE (1-(3,5,5,6,8,8-hexamethyl-5,6,7,8-tetrahydronaphthalen-2-yl) ethanone); FLORALOZONE (3-(4-ethylphenyl)-2,2-dimethylpropanal); FLORHYDRAL (3-(3-isopropylphenyl)butanal); FLORIDILE ((E)-undec-9-enenitrile); FLOROCYCLENE ((3aR,6S,7aS)-3a,4,5,6,7,7a-hexahydro-1H-4,7-methanoinden-6-yl propanoate); FLOROPAL (2,4,6-trimethyl-4-phenyl-1,3-dioxane); FLOROSA HC (tetrahydro-4-methyl-2-(2-methylpropyl)-2H-pyran-4-ol); FRESKOMENTHE (2-(sec-butyl)cyclohexanone); FRUCTONE (ethyl 2-(2-methyl-1,3-dioxolan-2-yl) acetate); FRUITATE ((3aS,4S,7R,7aS)-ethyl octahydro-1H-4,7-methanoindene-3a-carboxylate); FRUTONILE (2-methyldecanenitrile); GALBANONE PURE (1-(5,5-dimethylcyclohex-1-en-1-yl) pent-4-en-1-one); GARDENOL (1-phenylethyl acetate); GARDOCYCLENE ((3aR,6S,7aS)-3a,4,5,6,7,7a-hexahydro-1H-4,7-methanoinden-6-yl 2-methyl propanoate); GERANIOL ((E)-3,7-dimethylocta-2,6-dien-1-ol); GERANYL ACETATE ((E)-3,7-dimethylocta-2,6-dien-1-yl acetate); GERANYL CROTONATE ((E)-3,7-dimethylocta-2,6-dien-1-yl but-2-enoate); GERANYL ISOBUTYRATE ((E)-3,7-dimethylocta-2,6-dien-1-yl 2-methylpropanoate); GIVESCONE (ethyl 2-ethyl-6,6-dimethylcyclohex-2-enecarboxylate); α-GUAIENE ((1S,4S,7R)-1,4-dimethyl-7-(prop-1-en-2-yl)-1,2,3,4,5,6,7,8-octahydroazulene, neat, as a material comprising α-GUAIENE, such as patchouli oil, guaiac wood or a Guayacan tree; or obtained via a biochemical pathway), HABANOLIDE ((E)-oxacyclohexadec-12-en-2-one); HEDIONE (methyl 3-oxo-2-pentylcyclopentaneacetate); HELIOTROPINE CRYSTALS (benzo[d][1,3]dioxole-5-carbaldehyde); HERBANATE ((2S)-ethyl 3-isopropylbicyclo[2.2.1]hept-5-ene-2-carboxylate); HEXENAL-2-TRANS ((E)-hex-2-enal); HEXENOL-3-CIS ((Z)-hex-3-en-1-ol); HEXENYL-3-CIS ACETATE ((Z)-hex-3-en-1-yl acetate); HEXENYL-3-CIS BUTYRATE ((Z)-hex-3-en-1-yl butanoate); HEXENYL-3-CIS ISOBUTYRATE ((Z)-hex-3-en-1-yl 2-methylpropanoate); HEXENYL-3-CIS SALICYLATE ((Z)-hex-3-en-1-yl 2-hydroxybenzoate); HEXYL ACETATE (hexyl acetate); HEXYL BENZOATE (hexyl benzoate); HEXYL BUTYRATE (hexyl butanoate); HEXYL CINNAMIC ALDEHYDE ((E)-2-benzylideneoctanal); HEXYL ISOBUTYRATE (hexyl 2-methylpropanoate); HEXYL SALICYLATE (hexyl 2-hydroxybenzoate); HYDROXYCITRONELLAL (7-hydroxy-3,7-dimethyloctanal); INDOFLOR (4,4a,5,9b-tetrahydroindeno[1,2-d][1,3]dioxine); INDOLE PURE (1H-indole); INDOLENE (8,8-di(1H-indol-3-yl)-2,6-dimethyloctan-2-ol); IONONE BETA ((E)-4-(2,6,6-trimethylcyclohex-1-en-1-yl)but-3-en-2-one); IRISANTHEME ((E)-3-methyl-4-(2,6,6-trimethylcyclohex-2-en-1-yl)but-3-en-2-one); IRISONE ALPHA ((E)-4-(2,6,6-trimethylcyclohex-2-en-1-yl)but-3-en-2-one); IRONE ALPHA ((E)-4-(2,5,6,6-tetramethylcyclohex-2-en-1-yl)but-3-en-2-one); ISO E SUPER (1-(2,3,8,8-tetramethyl-1,2,3,4,5,6,7,8-octahydronaphthalen-2-yl)ethanone); ISOAMYL ACETATE (3-methylbutyl acetate); ISOAMYL BUTYRATE (3-methylbutyl butanoate); ISOBUTYL METHOXY PYRAZINE (2-methylpropyl 3-methoxypyrazine); ISOCYCLOCITRAL (2,4,6-trimethylcyclohex-3-enecarbaldehyde); ISOEUGENOL ((E)-2-methoxy-4-(prop-1-en-1-yl)phenol); ISOJASMONE B 11 (2-hexylcyclopent-2-en-1-one); ISOMENTHONE DL (2-isopropyl-5-methylcyclohexanone); ISONONYL ACETATE (3,5,5-trimethylhexyl acetate); ISOPROPYL METHYL-2-BUTYRATE (isopropyl 2-methylbutanoate); ISOPROPYL QUINOLINE (6-isopropylquinoline); ISORALDEINE ((E)-3-methyl-4-(2,6,6-trimethylcyclohex-2-en-1-yl)but-3-en-2-one); JASMACYCLENE ((3aR,6S,7aS)-3a,4,5,6,7,7a-hexahydro-1H-4,7-methanoinden-6-yl acetate); JASMONE CIS ((Z)-3-methyl-2-(pent-2-en-1-yl)cyclopent-2-enone); JASMONYL (3-butyl-5-methyltetrahydro-2H-pyran-4-yl acetate); JASMOPYRANE FORTE (3-pentyltetrahydro-2H-pyran-4-yl acetate); JAVANOL ((1-methyl-2-((1,2,2-trimethylbicyclo[3.1.0]hexan-3-yl)methyl)cyclopropyl)methanol); KOAVONE ((Z)-3,4,5,6,6-pentamethylhept-3-en-2-one); LAITONE (8-isopropyl-1-oxaspiro[4.5]decan-2-one); LEAF ACETAL ((Z)-1-(1-ethoxyethoxy)hex-3-ene); LEMONILE ((2E,6Z)-3,7-dimethylnona-2,6-dienenitrile); LIFFAROME ((Z)-hex-3-en-1-yl methyl carbonate); LILIAL (3-(4-(tert-butyl)phenyl)-2-methylpropanal); #N/ALINALOOL (3,7-dimethylocta-1,6-dien-3-ol); LINALOOL OXIDE (2-(5-methyl-5-vinyltetrahydrofuran-2-yl)propan-2-ol); LINALYL ACETATE (3,7-dimethylocta-1,6-dien-3-yl acetate); MAHONIAL ((4E)-9-hydroxy-5,9-dimethyl-4-decenal); MALTOL (3-hydroxy-2-methyl-4H-pyran-4-one); MALTYL ISOBUTYRATE (2-methyl-4-oxo-4H-pyran-3-yl 2-methylpropanoate); MANZANATE (ethyl 2-methylpentanoate); MAYOL ((4-isopropylcyclohexyl)methanol); MEFROSOL (3-methyl-5-phenylpentan-1-ol); MELONAL (2,6-dimethylhept-5-enal); #N/A #N/AMERCAPTO-8-METHANE-3-ONE (mercapto-para-menthan-3-one); METHYL ANTHRANILATE (methyl 2-aminobenzoate); METHYL BENZOATE (methyl benzoate); METHYL CEDRYL KETONE (1-((1S,8aS)-1,4,4,6-tetramethyl-2,3,3a,4,5,8-hexahydro-1H-5,8a-methanoazulen-7-yl)ethanone); METHYL CINNAMATE (methyl 3-phenylprop-2-enoate); METHYL DIANTILIS (2-ethoxy-4-(methoxymethyl)phenol); METHYL DIHYDRO ISOJASMONATE (methyl 2-hexyl-3-oxocyclopentane-1-carboxylate); METHYL HEPTENONE PURE (6-methylhept-5-en-2-one); METHYL LAITONE (8-methyl-1-oxaspiro[4.5]decan-2-one); METHYL NONYL KETONE (undecan-2-one); METHYL OCTYNE CARBONATE (methyl non-2-ynoate); METHYL PAMPLEMOUSSE (6,6-dimethoxy-2,5,5-trimethylhex-2-ene); METHYL SALICYLATE (methyl 2-hydroxybenzoate); MUSCENONE ((Z)-3-methylcyclopentadec-5-enone); MYRALDENE (4-(4-methylpent-3-en-1-yl)cyclohex-3-enecarbaldehyde); MYRCENE (7-methyl-3-methyleneocta-1,6-diene); MYSTIKAL (2-methylundecanoic acid); NECTARYL (2-(2-(4-methylcyclohex-3-en-1-yl)propyl)cyclopentanone); NEOBERGAMATE FORTE (2-methyl-6-methyleneoct-7-en-2-yl acetate); NEOCASPIRENE EXTRA (10-isopropyl-2,7-dimethyl-1-oxaspiro[4.5]deca-3,6-diene); NEOFOLIONE ((E)-methyl non-2-enoate); NEROLEX ((2Z)-3,7-dimethylocta-2,6-dien-1-ol); NEROLIDOL ((Z)-3,7,11-trimethyldodeca-1,6,10-trien-3-ol); NEROLIDYLE ((Z)-3,7,11-trimethyldodeca-1,6,10-trien-3-yl acetate); NEROLINE CRYSTALS (2-ethoxynaphthalene); NEROLIONE (1-(3-methylbenzofuran-2-yl) ethanone); NERYL ACETATE ((Z)-3,7-dimethylocta-2,6-dien-1-yl acetate); NIRVANOLIDE ((E)-13-methyloxacyclopentadec-10-en-2-one); NONADIENAL ((2E,6Z)-nona-2,6-dienal); NONADIENOL-2,6 ((2Z,6E)-2,6-nonadien-1-ol); NONADYL (6,8-dimethylnonan-2-ol); NONALACTONE GAMMA (5-pentyloxolan-2-one); NONENAL-6-CIS ((Z)-non-6-enal); NONENOL-6-CIS ((Z)-non-6-en-1-ol); NOPYL ACETATE (2-(6,6-dimethylbicyclo[3.1.1]hept-2-en-2-yl)ethyl acetate); NYMPHEAL (3-(4-(2-methylpropyl)-2-methylphenyl)propanal); OCTALACTONE DELTA (6-propyltetrahydro-2H-pyran-2-one); METHYL HEXYL KETONE (octan-2-one); ORANGER CRYSTALS (1-(2-naphtalenyl)-ethanone); ORIVONE (4-(tert-pentyl)cyclohexanone); PANDANOL ((2-methoxyethyl)benzene); PARA TERT BUTYL CYCLOHEXYL ACETATE (4-(tert-butyl)cyclohexyl acetate); PARADISAMIDE (2-ethyl-N-methyl-N-(m-tolyl)butanamide); PEACH PURE (5-heptyldihydrofuran-2(3H)-one); PELARGENE (2-methyl-4-methylene-6-phenyltetrahydro-2H-pyran); PELARGOL (3,7-dimethyloctan-1-ol); PEONILE (2-cyclohexylidene-2-phenylacetonitrile); PETALIA (2-cyclohexylidene-2-(o-tolyl)acetonitrile); PHARAONE (2-cyclohexylhepta-1,6-dien-3-one); PHENOXY ETHYL ISOBUTYRATE (2-(phenoxy)ethyl 2-methylpropanoate); PHENYL ACETALDEHYDE (2-phenyl-ethanal); PHENYL ETHYL ACETATE (2-phenylethyl acetate); PHENYL ETHYL ALCOHOL (2-phenylethanol); PHENYL ETHYL ISOBUTYRATE (2-phenylethyl 2-methylpropanoate); PHENYL ETHYL PHENYL ACETATE (2-phenylethyl 2-phenylacetate); PHENYL PROPYL ALCOHOL (3-phenylpropan-1-ol); PINENE ALPHA (2,6,6-trimethylbicyclo[3.1.1]hept-2-ene); PINENE BETA (6,6-dimethyl-2-methylenebicyclo[3.1.1]heptane); PINOACETALDEHYDE (3-(6,6-dimethylbicyclo[3.1.1]hept-2-en-2-yl) propanal); PIVAROSE (2,2-dimethyl-2-pheylethyl propanoate); POMAROSE ((2E,5E)-5,6,7-trimethylocta-2,5-dien-4-one); POMELOL (2,4,7-Trimethyl-6-octen-1-ol); PRECYCLEMONE B (1-methyl-4-(4-methylpent-3-en-1-yl) cyclohex-3-enecarbaldehyde); PRENYL ACETATE (3-methylbut-2-en-1-yl acetate); PRUNOLIDE (5-pentyldihydrofuran-2(3H)-one); RADJANOL SUPER ((E)-2-ethyl-4-(2,2,3-trimethylcyclopent-3-en-1-yl) but-2-en-1-ol); RASPBERRY KETONE (4-(4-hydroxyphenyl)butan-2-one); RHUBAFURAN (2,4-dimethyl-4-phenyltetrahydrofuran); ROSACETOL (2,2,2-trichloro-1-phenylethyl acetate); ROSALVA (dec-9-en-1-ol); ROSE OXIDE (4-methyl-2-(2-methylprop-1-en-1-yl) tetrahydro-2H-pyran); ROSE OXIDE CO (4-methyl-2-(2-methylprop-1-en-1-yl) tetrahydro-2H-pyran); ROSYFOLIA (1-methyl-2-(5-methylhex-4-en-2-yl)cyclopropylmethanol); ROSYRANE SUPER (4-methyl-2-phenyl-3,6-dihydro-2H-pyran); SAFRALEINE (2,3,3-trimethyl-1-indanone); SAFRANAL (2,6,6-trimethylcyclohexa-1,3-dienecarbaldehyde); SANDALORE EXTRA (3-methyl-5-(2,2,3-trimethylcyclopent-3-en-1-yl)pentan-2-ol); SCENTAURUS CLEAN (ethyl (Z)-2-acetyl-4-methyltridec-2-enoate); SCENTAURUS JUICY (4-(dodecylthio)-4-methylpentan-2-one); SERENOLIDE (2-(1-(3,3-dimethylcyclohexyl)ethoxy)-2-methylpropyl cyclopropanecarboxylate); SILVANONE SUPRA (cyclopentadecanone, hexadecanolide); SILVIAL (2-methyl-3-[4-(2-methylpropyl)phenyl]propanal); SPIROGALBANONE (1-(spiro[4.5]dec-6-en-7-yl)pent-4-en-1-one); STEMONE ((E)-5-methylheptan-3-one oxime); STYRALLYL ACETATE (1-phenylethyl acetate); SUPER MUGUET ((E)-6-ethyl-3-methyloct-6-en-1-ol); SYLKOLIDE ((E)-2-((3,5-dimethylhex-3-en-2-yl)oxy)-2-methylpropyl cyclopropanecarboxylate); TERPINENE ALPHA (1-methyl-4-propan-2-ylcyclohexa-1,3-diene); TERPINENE GAMMA (1-methyl-4-propan-2-ylcyclohexa-1,4-diene); TERPINEOL (2-(4-methylcyclohex-3-en-1-yl)propan-2-ol); TERPINEOL ALPHA (2-(4-methyl-1-cyclohex-3-enyl)propan-2-ol); TERPINEOL PURE (2-(4-methylcyclohex-3-en-1-yl)propan-2-ol); TERPINOLENE (1-methyl-4-(propan-2-ylidene)cyclohex-1-ene); TERPINYL ACETATE (2-(4-methyl-1-cyclohex-3-enyl)propan-2-yl acetate); TETRAHYDRO LINALOOL (3,7-dimethyloctan-3-ol); TETRAHYDRO MYRCENOL (2,6-dimethyloctan-2-ol); THIBETOLIDE (oxacyclohexadecan-2-one); THYMOL (2-isopropyl-5-methylphenol); TOSCANOL (1-(cyclopropylmethyl)-4-methoxybenzene); TRICYCLAL (2,4-dimethylcyclohex-3-enecarbaldehyde); TRIDECENE-2-NITRILE ((E)-tridec-2-enenitrile); TRIFERNAL (3-phenylbutanal); TROPIONAL (3-(benzo[d][1,3]dioxol-5-yl)-2-methylpropanal); TROPIONAL (3-(benzo[d][1,3]dioxol-5-yl)-2-methylpropanal); UNDECATRIENE ((3E,5Z)-undeca-1,3,5-triene); UNDECAVERTOL ((E)-4-methyldec-3-en-5-ol); VANILLIN (4-hydroxy-3-methoxybenzaldehyde); VELOUTONE (2,2,5-trimethyl-5-pentylcyclopentanone); VELVIONE ((Z)-cyclohexadec-5-enone); VIOLET NITRILE ((2E,6Z)-nona-2,6-dienenitrile); YARA YARA (2-methoxynaphtalene); ZINARINE (2-(2,4-dimethylcyclohexyl)pyridine; BOIS CEDRE ESS CHINE (cedar wood oil); EUCALYPTUS GLOBULUS ESS CHINA (eucalyptus oil); GALBANUM ESS (galbanum oil); GIROFLE FEUILLES ESS RECT MADAGASCAR (clove oil); LAVANDIN GROSSO OIL FRANCE ORPUR (lavandin oil); MANDARIN OIL WASHED COSMOS (mandarin oil); ORANGE TERPENES (orange terpenes); PATCHOULI ESS INDONESIE (patchouli oil); YLANG ECO ESSENCE (ylang oil); and combinations thereof. These fragrance ingredients are particularly suitable for obtaining stable and performing microcapsules, owing to their favorable lipophilicity and olfactive performance.

In particularly preferred embodiments of the present invention, more than 75 wt.-%, preferably more than 80 wt.-%, even more preferably more than 85 wt.-%, even still more preferably more than 90 wt.-%, even yet still more preferably more than 95 wt.-%, of the fragrance ingredients are biodegradable and selected from ACETYL ISOEUGENOL ((E)-2-methoxy-4-(prop-1-en-1-yl)phenyl acetate); ADOXAL (2,6,10-trimethylundec-9-enal); AGRUMEX (2-(tert-butyl)cyclohexyl acetate); ALDEHYDE C 10 DECYLIC (decanal); ALDEHYDE C 11 UNDECYLENIC (undec-10-enal); ALDEHYDE C 110 UNDECYLIC (undecanal); ALDEHYDE C 12 LAURIC (dodecanal); ALDEHYDE C 12 MNA (2-methylundecanal); ALDEHYDE C 8 OCTYLIC (octanal); CYCLAMEN ALDEHYDE EXTRA (3-(4-isopropylphenyl)-2-methylpropanal); ALDEHYDE ISO C 11 ((E)-undec-9-enal); ALLYL AMYL GLYCOLATE (prop-2-enyl 2-(3-methylbutoxy)acetate); ALLYL CYCLOHEXYL PROPIONATE (prop-2-enyl 3-cyclohexylpropanoate); ALLYL OENANTHATE (prop-2-enyl heptanoate); AMBRETTOLIDE ((Z)-oxacycloheptadec-10-en-2-one); AMBROFIX ((3aR,5aS,9aS,9bR)-3a,6,6,9a-tetramethyl-2,4,5,5a,7,8,9,9b-octahydro-1H-benzo[e][1]benzofuran); AMYL SALICYLATE (pentyl 2-hydroxybenzoate); AUBEPINE PARA CRESOL (4-methoxybenzaldehyde); BENZYL ACETATE (benzyl acetate); BENZYL SALICYLATE (benzyl 2-hydroxybenzoate); BORNYL ACETATE ((2S,4S)-1,7,7-trimethylbicyclo[2.2.1]heptan-2-yl acetate); CARVACROL (5-isopropyl-2-methylphenol); CEDRENE ((1S,8aR)-1,4,4,6-tetramethyl-2,3,3a,4,5,8-hexahydro-1H-5,8a-methanoazulene); CEDRYL ACETATE ((1S,6R,8aR)-1,4,4,6-tetramethyloctahydro-1H-5,8a-methanoazulen-6-yl acetate); CEDRYL METHYL ETHER ((1R,6S,8aS)-6-methoxy-1,4,4,6-tetramethyloctahydro-1H-5,8a-methanoazulene); CITRAL ((E)-3,7-dimethylocta-2,6-dienal); CITRONELLOL (3,7-dimethyloct-6-en-1-ol); CITRONELLYL ACETATE (3,7-dimethyloct-6-en-1-yl acetate); COSMONE ((Z)-3-methylcyclotetradec-5-enone); CRESYL METHYL ETHER PARA (1-methoxy-4-methylbenzene); CYCLOHEXYL ETHYLACETATE (2-cyclohexylethyl acetate); CYCLOHEXYL SALICYLATE (cyclohexyl 2-hydroxybenzoate); DAMASCENONE ((E)-1-(2,6,6-trimethylcyclohexa-1,3-dien-1-yl)but-2-en-1-one); DAMASCONE ALPHA ((E)-1-(2,6,6-trimethylcyclohex-2-en-1-yl)but-2-en-1-one); DECALACTONE GAMMA (5-hexyloxolan-2-one); DECENAL-4-TRANS ((E)-dec-4-enal); DIHYDRO MYRCENOL (2,6-dimethyloct-7-en-2-ol); DIPHENYL OXIDE (oxydibenzene); DIHYDRO ANETHOLE (1-methoxy-4-propylbenzene); DIHYDRO JASMONE (3-methyl-2-pentylcyclopent-2-enone); DIMETHYL ANTHRANILATE (methyl 2-(methylamino)benzoate); DIMETHYL BENZYL CARBINYL ACETATE (2-methyl-1-phenylpropan-2-yl acetate); DIMETHYL BENZYL CARBINYL BUTYRATE (2-methyl-1-phenylpropan-2-yl butanoate); DIMETOL (2,6-dimethylheptan-2-ol); DODECALACTONE DELTA (6-heptyltetrahydro-2H-pyran-2-one); DODECALACTONE GAMMA (5-octyloxolan-2-one); DODECENAL ((E)-dodec-2-enal); EBANOL ((E)-3-methyl-5-(2,2,3-trimethylcyclopent-3-en-1-yl)pent-4-en-2-ol); ETHYL HEXANOATE (ethyl hexanoate); ETHYL METHYL-2-BUTYRATE (ethyl 2-methyl butyrate); ETHYL MALTOL (2-ethyl-3-hydroxy-4H-pyran-4-one); ETHYL OENANTHATE (ethyl heptanoate); ETHYL VANILLIN (3-ethoxy-4-hydroxybenzaldehyde); ETHYLENE BRASSYLATE (1,4-dioxacycloheptadecane-5,17-dione); EUCALYPTOL ((1s,4s)-1,3,3-trimethyl-2-oxabicyclo[2.2.2]octane); EUGENOL (4-allyl-2-methoxyphenol); EVERNYL (methyl 2,4-dihydroxy-3,6-dimethylbenzoate); FIXAMBRENE (3a,6,6,9a-tetramethyldodecahydronaphtho[2,1-b]furan); FLORHYDRAL (3-(3-isopropylphenyl)butanal); FLORIDILE ((E)-undec-9-enenitrile); GALBANONE PURE (1-(5,5-dimethylcyclohex-1-en-1-yl)pent-4-en-1-one); GARDENOL (1-phenylethyl acetate); GERANIOL ((E)-3,7-dimethylocta-2,6-dien-1-ol); GERANYLACETATE ((E)-3,7-dimethylocta-2,6-dien-1-yl acetate); HABANOLIDE ((E)-oxacyclohexadec-12-en-2-one); HEDIONE (methyl 3-oxo-2-pentylcyclopentaneacetate); HEXENAL-2-TRANS ((E)-hex-2-enal); HEXENOL-3-CIS ((Z)-hex-3-en-1-ol); HEXENYL-3-CIS ACETATE ((Z)-hex-3-en-1-yl acetate); HEXENYL-3-CIS SALICYLATE ((Z)-hex-3-en-1-yl 2-hydroxybenzoate); HEXYL ACETATE (hexyl acetate); INDOLENE (8,8-di(1H-indol-3-yl)-2,6-dimethyloctan-2-ol); IONONE BETA ((E)-4-(2,6,6-trimethylcyclohex-1-en-1-yl)but-3-en-2-one); IRISANTHEME ((E)-3-methyl-4-(2,6,6-trimethylcyclohex-2-en-1-yl)but-3-en-2-one); IRISONE ALPHA ((E)-4-(2,6,6-trimethylcyclohex-2-en-1-yl)but-3-en-2-one); ISOAMYL ACETATE (3-methylbutyl acetate); ISOAMYL BUTYRATE (3-methylbutyl butanoate); ISOEUGENOL ((E)-2-methoxy-4-(prop-1-en-1-yl)phenol); ISOJASMONE B 11 (2-hexylcyclopent-2-en-1-one); ISORALDEINE ((E)-3-methyl-4-(2,6,6-trimethylcyclohex-2-en-1-yl)but-3-en-2-one); JASMONYL (3-butyl-5-methyltetrahydro-2H-pyran-4-yl acetate); LAITONE (8-isopropyl-1-oxaspiro[4.5]decan-2-one); LEMONILE ((2E,6Z)-3,7-dimethylnona-2,6-dienenitrile); LINALOOL (3,7-dimethylocta-1,6-dien-3-ol); LINALOOL OXIDE (2-(5-methyl-5-vinyltetrahydrofuran-2-yl) propan-2-ol); LINALYL ACETATE (3,7-dimethylocta-1,6-dien-3-yl acetate); MANZANATE (ethyl 2-methylpentanoate); MAYOL ((4-isopropylcyclohexyl) methanol); MEFROSOL (3-methyl-5-phenylpentan-1-ol); MELONAL (2,6-dimethylhept-5-enal); MERCAPTO-8-METHANE-3-ONE (mercapto-para-menthan-3-one); METHYL ANTHRANILATE (methyl 2-aminobenzoate); METHYL BENZOATE (methyl benzoate); METHYL DIANTILIS (2-ethoxy-4-(methoxymethyl)phenol); METHYL HEPTENONE PURE (6-methylhept-5-en-2-one); METHYL LAITONE (8-methyl-1-oxaspiro[4.5]decan-2-one); METHYL OCTYNE CARBONATE (methyl non-2-ynoate); METHYL SALICYLATE (methyl 2-hydroxybenzoate); NECTARYL (2-(2-(4-methylcyclohex-3-en-1-yl)propyl)cyclopentanone); NEOFOLIONE ((E)-methyl non-2-enoate); NEROLEX ((2Z)-3,7-dimethylocta-2,6-dien-1-ol); NEROLIDOL ((Z)-3,7,11-trimethyldodeca-1,6,10-trien-3-ol); NEROLINE CRYSTALS (2-ethoxynaphthalene); NEROLIONE (1-(3-methylbenzofuran-2-yl)ethanone); NERYL ACETATE ((Z)-3,7-dimethylocta-2,6-dien-1-yl acetate); NONADIENAL ((2E,6Z)-nona-2,6-dienal); NONENAL-6-CIS ((Z)-non-6-enal); NONENOL-6-CIS ((Z)-non-6-en-1-ol); NYMPHEAL (3-(4-(2-methylpropyl)-2-methylphenyl)propanal); OCTALACTONE DELTA (6-propyltetrahydro-2H-pyran-2-one); ORANGER CRYSTALS (1-(2-naphtalenyl)-ethanone); PARA TERT BUTYL CYCLOHEXYL ACETATE (4-(tert-butyl)cyclohexyl acetate); PEACH PURE (5-heptyldihydrofuran-2(3H)-one); PELARGOL (3,7-dimethyloctan-1-ol); PHENYL ETHYLACETATE (2-phenylethyl acetate); PINENE ALPHA (2,6,6-trimethylbicyclo[3.1.1]hept-2-ene); PINENE BETA (6,6-dimethyl-2-methylenebicyclo[3.1.1]heptane); POMAROSE ((2E,5E)-5,6,7-trimethylocta-2,5-dien-4-one); POMELOL FF (2,4,7-Trimethyl-6-octen-1-ol); PRENYLACETATE (3-methylbut-2-en-1-yl acetate); PRUNOLIDE (5-pentyldihydrofuran-2(3H)-one); RASPBERRY KETONE (4-(4-hydroxyphenyl)butan-2-one); ROSALVA (dec-9-en-1-ol); ROSE OXIDE CO (4-methyl-2-(2-methylprop-1-en-1-yl)tetrahydro-2H-pyran); ROSYRANE SUPER (4-methyl-2-phenyl-3,6-dihydro-2H-pyran); SAFRANAL (2,6,6-trimethylcyclohexa-1,3-dienecarbaldehyde); SCENTAURUS JUICY (4-(dodecylthio)-4-methylpentan-2-one); SILVIAL (2-methyl-3-[4-(2-methylpropyl)phenyl]propanal); STYRALLYL ACETATE (1-phenylethyl acetate); SYLKOLIDE ((E)-2-((3,5-dimethylhex-3-en-2-yl) oxy)-2-methylpropyl cyclopropanecarboxylate); TERPINENE GAMMA (1-methyl-4-propan-2-ylcyclohexa-1,4-diene); TERPINEOL (2-(4-methylcyclohex-3-en-1-yl)propan-2-ol); TERPINOLENE (1-methyl-4-(propan-2-ylidene)cyclohex-1-ene); TETRAHYDRO LINALOOL (3,7-dimethyloctan-3-ol); TOSCANOL (1-(cyclopropylmethyl)-4-methoxybenzene); TRIDECENE-2-NITRILE ((E)-tridec-2-enenitrile); TRIFERNAL (3-phenylbutanal); TROPIONAL (3-(benzo[d][1,3]dioxol-5-yl)-2-methylpropanal); UNDECAVERTOL ((E)-4-methyldec-3-en-5-ol); YARA YARA (2-methoxynaphtalene); BOIS CEDRE ESS CHINE (cedar wood oil); EUCALYPTUS GLOBULUS ESS CHINA (eucalyptus oil); GALBANUM ESS (galbanum oil); GIROFLE FEUILLES ESS RECT MADAGASCAR (clove oil); LAVANDIN GROSSO OIL FRANCE ORPUR (lavandin oil); MANDARIN OIL WASHED COSMOS (mandarin oil); ORANGE TERPENES (orange terpenes); PATCHOULI ESS INDONESIE (patchouli oil); YLANG ECO ESSENCE (ylang oil); and combinations thereof. These ingredients have the advantage of providing microcapsules which are particularly sustainable.

The core composition may also comprise at least one fragrance precursor, meaning a material that is capable of releasing a fragrance ingredient by the means of a stimulus, such as a change of temperature, the presence of oxidants, the action of enzymes or the action of light. Such fragrance precursors are well-known to the art.

### Bleach-Free Laundry Sanitizer Base

Bleach-free laundry sanitizers are available on the market as clear liquids, colourless or lightly coloured, unperfumed or lightly scented. These compositions are typically water-based.

The antibacterial ingredients employed in bleach-free laundry sanitizers belong, generally, to a class of compounds known as quaternary ammonium compounds (QACs or “quats”). Examples of such compounds include dimethyl ammonium chloride, dimethyl benzyl ammonium chloride (ADBAC), alkyl C12-16 dimethyl benzyl ammonium chloride and dicapryl/dicaprylyl dimonium chloride (mixed dialkyl (C8-C10) dimethyl ammonium chloride). Quaternary ammonium compounds are cationic surfactants (surface active agents) that combine bactericidal and virucidal activity with good cleaning ability.

Quaternary ammonium cations, also known as quats, are positively charged polyatomic ions of the structure NR⁺₄, R being an alkyl group or an aryl group. Unlike the ammonium ion (NH⁺₄) and the primary, secondary, or tertiary ammonium cations, the quaternary ammonium cations are permanently charged, independent of the pH of their solution.

Quaternary ammonium compounds have been widely employed in fabric softener or fabric conditioner compositions. Contemporary fabric softeners are based on salts of quaternary ammonium cations where the fatty acid is linked to the quaternary center via ester linkages (ester-quats). Characteristically, the cations contain one or two long alkyl chains derived from fatty acids linked to an ethoxylated ammonium salt. Examples of such QACs are diethyl ester dimethyl ammonium chloride triethanolamine (DEEDMAC), quat (TEAQ), dihydrogenated tallowamidoethyl hydroxyethylmonium methosulfate and Hamburg esterquat (HEQ). It is believed that these QACs bind electrostatically to the negatively charged groups on the surface of the fibers, with their hydrophobic groups away from the fibers, thereby reducing friction between the fibers and imparting softness. The pH of these systems is typically 4 or below. In order to show softening activity, typical formulations must contain between about 4 wt % to about 6 wt % QACs. These compounds are generally not water soluble, therefore in order to obtain a homogeneously-looking laundry softener high shear mixing is needed to suspend the materials and the final product will appear opaque.

On the other hand, the quaternary ammonium compounds with an antibacterial role contain long alkyl chains and are believed to act by disrupting the cell membrane or viral envelope of microorganisms. In sanitizing compositions, approximately about 1 wt % to about 4 wt % of quats is needed to achieve disinfection. The final products do not require high shear mixing and tend to be clear systems. The pH of these systems is generally 7 and above.

In one embodiment, the quaternary ammonium compounds employed in the bleach-free laundry sanitizer composition are selected from the group consisting of dimethyl ammonium chloride of formula I, wherein R₁ and R₂ are independently a C₈-C₁₆ alkyl, such as octyl, decyl, dodecyl and mixtures thereof

NMe₂R₁R₂⁺Cl⁻ formula I;

alkyldimethylbenzylammonium chloride of formula II, wherein n=8, 10, 12, 14, 16, 18 and mixtures thereof

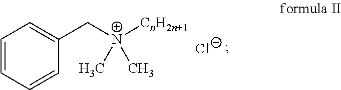

and mixtures thereof.

In one embodiment, the quaternary ammonium compounds employed in the bleach-free laundry sanitizer composition are selected from the group consisting of dimethyl ammonium chloride of formula I, wherein R₁ and R₂ are independently octyl, decyl, dodecyl and mixtures thereof, such as didecyldimethylammonium chloride (DDAC) or dicapryl/dicaprylyl dimonium chloride (mixed dialkyl (C8-C10) dimethyl ammonium chloride); alkyldimethylbenzylammonium chloride of formula II, wherein n=8, 10, 12, 14, 16, 18 and mixtures thereof, such as ADBAC, which is a mixture of alkyl-benzyldimethylammonium chlorides in which the alkyl group has various even-numbered alkyl chain lengths, for example alkyl C12-16 dimethyl benzyl ammonium chloride; and mixtures thereof.

In one embodiment, the quaternary ammonium compounds are employed at a level between about 0.5 wt % to about 4.5 wt %, optionally between about 1 wt % to about 4 wt %, in the bleach-free laundry sanitizer composition.

In addition to the antibacterial agents, the laundry sanitizer compositions may contain surfactants such as C12-16 alcohol ethoxylated, rheology modifiers such as hydroxyethylcellulose, anti-redeposition aids such as syrups, hydrolyzed starches, polymers, solubilisers such as glyoxal and dyes.

pH stabilizers such as sodium carbonate and sodium bicarbonate may also be present in the commercial bleach-free laundry sanitizers. The pH of the commercial laundry sanitizers generally ranges from neutral (pH about 7) to basic (pH about 10).

In one embodiment, the pH of the bleach-free laundry sanitizer base is between about 7 to about 10.

Commercially available bleach-free laundry sanitizers also contain various amounts of alcohol, such as ethanol and isopropanol.

In one embodiment, the bleach-free laundry sanitizer base comprises an alcohol such as ethanol or isopropanol.

In one embodiment, the bleach-free laundry sanitizer base is commercially available Fragrance free Lysol Laundry Sanitizer.

In one embodiment, the bleach-free laundry sanitizer base is commercially available Clorox Laundry sanitizer.

### Bleach-Free Laundry Sanitizer Composition Comprising Microcapsule Composition

Relatively harsh environments provided by a consumer product base, such as consumer bases having an acidic or a basic pH, or those containing organic solvents like alcohols, can degrade the microcapsule shell wall and accelerate diffusion of the core through the shell wall prematurely through leakage. It is common in the industry to employ alcohols such as ethanol and isopropanol to extract fragrance from encapsulated fragrance compositions, due to their excellent solvent properties.

Likewise, it is known that consumer product bases having a pH above 8, such as liquid laundry detergents, act as an extractive medium for fragrance from the microcapsules of encapsulated fragrances, with high level of fragrance leaking from the capsule into the consumer product base, with the effect that the expected release profile of the fragrance is disrupted.

Generally, bleach-free laundry sanitizer bases have a pH of 7 or higher and employ quaternary ammonium surfactants as described hereinabove at a level of between about 1 wt % to about 4 wt %. Most bleach-free laundry sanitizer bases also contain certain levels of alcohols. As such, it is expected that the stability and performance of core-shell microcapsules encapsulating benefit agent, when incorporated in such a consumer product base, is negatively affected by the presence of alcohol. Likewise, it is expected that the stability and performance of core-shell microcapsules encapsulating benefit agent is negatively affected by such a consumer product base having a pH above about 7.

However, the applicant has found, surprisingly and unexpectedly, that a mixture of bleach-free laundry sanitizer base and at least one microcapsule composition comprising a polymer encapsulating a fragrance, wherein the fragrance is encapsulated in core-shell microcapsules comprising a core and a shell surrounding the core is able to provide, at the same time as sanitizing the laundry, a consumer perception of the fragrance throughout the washing and rinsing cycles, at the moment the laundry is taken out of the machine, during drying and after the laundry has been dried.

In one embodiment, the level of fragrance in the resulting bleach-free laundry sanitizer composition comprising at least one microcapsule composition comprising a polymer encapsulating a fragrance is between about 0.02% to about 0.40%, optionally between about 0.05% to about 0.25%, optionally about 0.10% to about 0.13% neat oil equivalence of fragrance.

In one embodiment, the laundry sanitizer composition comprises at least one alcohol, such as ethanol or isopropanol.

In one embodiment, the laundry sanitizer composition has a pH between about 7 to about 10.

In one embodiment, the microcapsules employed in the bleach-free laundry sanitizer are polyurea capsules. In one embodiment, the polyurea microcapsules are as described in WO 2016/071149A1.

In one embodiment, the bleach-free laundry sanitizer composition comprises Fragrance free Lysol Laundry Sanitizer base, comprising quaternary ammonium compounds selected from the group consisting of dimethyl ammonium chloride of formula I, wherein R₁ and R₂ are independently octyl, decyl, dodecyl, alkyldimethylbenzylammonium chloride of formula II, wherein n=8, 10, 12, 14, 16, 18 and mixtures thereof; and polyurea microcapsules, optionally polyurea microcapsules as described in WO 2016/071149A1. Optionally, the level of quaternary ammonium compounds in the bleach-free laundry sanitizer composition is between about 1 wt % to about 4 wt %. Optionally, the level of fragrance in the bleach-free laundry sanitizer composition is between about 0.10% to 0.13% neat oil equivalence of fragrance.

In one embodiment, the bleach-free laundry sanitizer composition comprises Clorox Laundry sanitizer base comprising quaternary ammonium compounds selected from the group consisting of dimethyl ammonium chloride of formula I, wherein R₁ and R₂ are independently octyl or decyl such as dicapryl/dicaprylyl dimonium chloride (mixed dialkyl (C8-C10) dimethyl ammonium chloride), alkyldimethylbenzylammonium chloride of formula II, wherein n=8, 10, 12, 14, 16, 18, such as alkyl C12-16 dimethyl benzyl ammonium chloride and mixtures thereof; and polyurea microcapsules, optionally polyurea microcapsules as described in WO 2016/071149A1. Optionally, the level of quaternary ammonium compounds in the bleach-free laundry sanitizer composition is between about 1 wt % to about 4 wt %. Optionally, the level of fragrance in the bleach-free laundry sanitizer composition is between about 0.10% to 0.13% neat oil equivalence of fragrance.

In one embodiment, the microcapsules employed in the bleach-free laundry sanitizer are microcapsules comprising a hydrated polymer phase and a polymeric stabilizer, as described hereinabove. In one embodiment, the polymeric stabilizer is formed by reaction of a bipodal aminosilane such as bis(3-(triethoxysilyl)propyl)amine with 2-ethylpropane-1,2,3-triyl tris((3-(isocyanatomethyl)phenyl)carbamate). In one embodiment, the hydrated polymer phase the hydrated polymer phase is a complex coacervate formed from a polycation such as gelatin, casein, albumin, polylysine, soy proteins, pea proteins, rice proteins or hemp proteins, preferably a Type B gelatin; and a polyanion such as pectin, gum arabic and alginate, preferably pectin.

In one embodiment, the bleach-free laundry sanitizer composition comprises Fragrance free Lysol Laundry Sanitizer base comprising quaternary ammonium compounds selected from the group consisting of dimethyl ammonium chloride of formula I, wherein R₁ and R₂ are independently octyl, decyl, dodecyl, alkyldimethylbenzylammonium chloride of formula II, wherein n=8, 10, 12, 14, 16, 18 and mixtures thereof; and microcapsules comprising a hydrated polymer phase and a polymeric stabilizer as described hereinabove. Optionally, the level of quaternary ammonium compounds in the bleach-free laundry sanitizer composition is between about 1 wt % to about 4 wt %. Optionally, the level of fragrance in the bleach-free laundry sanitizer composition is between about 0.10% to 0.13% neat oil equivalence of fragrance.

In one embodiment, the bleach-free laundry sanitizer composition comprises Clorox Laundry sanitizer base comprising quaternary ammonium compounds selected from the group consisting of dimethyl ammonium chloride of formula I, wherein R₁ and R₂ are independently octyl or decyl such as dicapryl/dicaprylyl dimonium chloride (mixed dialkyl (C8-C10) dimethyl ammonium chloride), alkyldimethylbenzylammonium chloride of formula II, wherein n=8, 10, 12, 14, 16, 18, such as alkyl C12-16 dimethyl benzyl ammonium chloride and mixtures thereof; and microcapsules comprising a hydrated polymer phase and a polymeric stabilizer as described hereinabove. Optionally, the level of quaternary ammonium compounds in the bleach-free laundry sanitizer composition is between about 1 wt % to about 4 wt %. Optionally, the level of fragrance in the bleach-free laundry sanitizer composition is between about 0.10% to 0.13% neat oil equivalence of fragrance.

In one embodiment, the microcapsules employed in the bleach-free laundry sanitizer are microcapsules comprising a complex coacervate formed of at least one protein and at least one polysaccharide. In one embodiment, the microcapsules comprising a complex coacervate are as described in WO 2021/239742A1.

In one embodiment, the bleach-free laundry sanitizer composition comprises Fragrance free Lysol Laundry Sanitizer base comprising quaternary ammonium compounds selected from the group consisting of dimethyl ammonium chloride of formula I, wherein R₁ and R₂ are independently octyl, decyl, dodecyl, alkyldimethylbenzylammonium chloride of formula II, wherein n=8, 10, 12, 14, 16, 18 and mixtures thereof; and microcapsules comprising a complex coacervate formed of at least one protein and at least one polysaccharide, optionally microcapsules as described in WO 2021/239742A1. Optionally, the level of quaternary ammonium compounds in the bleach-free laundry sanitizer composition is between about 1 wt % to about 4 wt %. Optionally, the level of fragrance in the bleach-free laundry sanitizer composition is between about 0.10% to 0.13% neat oil equivalence of fragrance.

In one embodiment, the bleach-free laundry sanitizer composition comprises Clorox Laundry sanitizer base comprising quaternary ammonium compounds selected from the group consisting of dimethyl ammonium chloride of formula I, wherein R₁ and R₂ are independently octyl or decyl such as dicapryl/dicaprylyl dimonium chloride (mixed dialkyl (C8-C10) dimethyl ammonium chloride), alkyldimethylbenzylammonium chloride of formula II, wherein n=8, 10, 12, 14, 16, 18, such as alkyl C12-16 dimethyl benzyl ammonium chloride and mixtures thereof; and microcapsules comprising a complex coacervate formed of at least one protein and at least one polysaccharide, optionally microcapsules as described in WO 2021/239742A1. Optionally, the level of quaternary ammonium compounds in the bleach-free laundry sanitizer composition is between about 1 wt % to about 4 wt %. Optionally, the level of fragrance in the bleach-free laundry sanitizer composition is between about 0.10% to 0.13% neat oil equivalence of fragrance.

In one embodiment, the laundry sanitizer composition further comprises a laundry care additive. Laundry care additives may be selected from stain removal compounds, fabric conditioning compounds, wrinkle reduction compounds, colour enhancers, and combinations thereof. Optionally, the laundry care additive is a fabric conditioning compound.

### Method of Making

In one aspect, the present invention provides a method of making a bleach-free laundry sanitizer composition comprising encapsulated fragrance.

The method comprises the step of mixing a composition comprising core-shell encapsulated benefit agent into a bleach-free laundry sanitizer base composition, to produce a bleach-free laundry sanitizer composition.

The microcapsule composition employed may be in the form of liquid slurries, powder, granulates, flakes or extrudates.

The microcapsule composition and the non-bleach laundry sanitizer bases are as described hereinabove.

The level of fragrance in the bleach-free laundry sanitizer composition is as defined hereinabove.

### Use

In yet another aspect, the present invention relates to the use of an encapsulated composition as described hereinabove to improve the perception or enhance the performance of a bleach-free laundry sanitizer composition as described hereinabove.

The present invention is further illustrated by means of the following non-limiting examples:

### Example 1: Preparation of Fragrance-Encapsulating Microcapsule Slurries With Cores of Various Chemistries

The following microcapsules were prepared as described in Table 1.

TABLE 1
Microcapsules and methods of preparation

| | | Fragrance Load |
|---|---|---|
| Example | Method | (%) |
| 1.1 | WO 2018/197266A1 Example 3 | 35% |
| 1.2 | WO 2016/207180A1 Example 1 | 35% |
| 1.3 | WO 2016/071149A1 Example 2 | 31% |
| 1.4 | As described below | 31% |
| 1.5 | WO 2021/239742A1 Examples 1.1 to 1.5 | 25% |

The capsules of Example 1.4 were prepared as follows
a) A core composition was prepared by admixing 0.7 g of bipodal aminosilane (bis(3-triethoxysilylpropyl)amine), 0.48 g Takenate D-110N (ex Mitsui) and 38.5 g of fragrance composition;
b) The core composition obtained in step a) was emulsified in a mixture of 1.0 g high methoxylated grade pectin (of type APA 104, ex Roeper) in 73.3 g of water by using a 300 ml reactor and a cross-beam stirrer with pitched beam operating at a stirring speed of 600 rpm at a temperature of 25+/−2° C. for 10 min;
c) The temperature of the system was raised to 85+/−2° C. over 4 hours, 0.3 g of trimesic acid (1,3,5-benzenetricarboxylic acid) were added and the system was maintained at this temperature for 1.3 h while maintaining stirring as in step b);
d) The system was slowly cooled to 40° C. over 2.25 hours, while maintaining stirring as in step b);
e) At a temperature of 40+/−2° C., 10 g of a 10% gelatin solution in water was added, while maintaining stirring as in step b);
f) The system was slowly cooled to 10° C. over 2.25 hours, while maintaining stirring as in step b);
g) Once the system had reached the temperature of 10° C., 0.02 g of a 50 wt.-% glutaraldehyde solution in water was added and the system was maintained at this temperature for 1 hour, while maintaining stirring as in step b), in order to form a slurry of core-shell microcapsules;
h) The slurry of core-shell capsules obtained in step f) was finally let to stabilize at room temperature.

### Example 2: Evaluation of the Stability of the Encapsulated Fragrance in Commercially Available Bleach-Free Laundry Sanitizer Bases

Two commercially available bleach-free laundry sanitizer bases were employed for testing
A. Fragrance free Lysol Laundry Sanitizer
B. Clorox Laundry sanitizer

The composition and the pH of the two bleach-free laundry sanitizer bases is as shown in Table 2.

TABLE 2
The composition and the pH of the two laundry sanitizer bases A and B

| Function | A | B |
|---|---|---|
| Antibacterial | Dimethyl Ammonium | Dicapryl/Dicaprylyl |
| Agent | Chloride | Dimonium Chloride |
| | (various chain lengths) | |
| | Dimethyl Benzyl | Alkyl C12-16 |
| | Ammonium Chloride | Dimethylbenzyl |
| | | Ammonium Chloride |
| surfactant | C12-16 Alcohol | Decylamine Oxide |
| Thickener/stabilizer | Ethoxylated | Sodium Chloride |
| Rheology Modifier | | Hydroxyethylcellulose |
| Anti-redeposition | | Syrups, Hydrolyzed |
| Aids | | Starches, Polymers |
| Solubilizer | | Glyoxal |
| Dye | colorant | colorant |
| pH adjuster | Sodium Carbonate | |
| | Sodium Bicarbonate | |
| solvent | Water | Water |
| | Ethanol | Ethanol |
| pH | 10 | 7 |

The stability of the microcapsules of Examples 1.1 to 1.5 in each of the two bleach-free laundry sanitizer bases A and B was tested as follows:
I. The slurries of microcapsules prepared according to Example 1. to 1.5 were incorporated into the sanitizer base; the resulting samples were stored at RT (room temperature, about 25° C.) and at 40° C.
II. Laundry was washed+dried initially and the pre-rub and post-rub performance recorded by the Sensory Panel;
III. The samples of bleach-free laundry sanitizer comprising microcapsules were removed from storage and employed in washing after 2, 4, 8, and 12 weeks; performance over time and temperature was monitored by the Sensory Panel as described in step II.
I. The slurries in Examples 1.1 to 1.5 were mixed in each of the two bleach-free laundry sanitizer bases A and B such that the level of fragrance in the resulting bleach-free laundry sanitizer was about 0.10% to 0.13% neat oil equivalence. The bleach-free sanitizer base was added to a beaker and the capsule slurry was slowly mixed in using overhead mixer with 4 prong propeller or magnetic stir bar (set rpm to obtain a vortex) and mixed for 10 minutes. The samples were stored in appropriate stability condition until needed.
II. The resulting bleach-free laundry sanitizer were tested on laundry as follows:
   GE Washing and dryer stackable model #GUD27ESSJ1WW
   Small load, warm wash, cold rinse, 15-25 washcloths (depending on testing)
   30 grams of Tide Free & Gentle Liquid Detergent
   Laundry Sanitizer according to the invention or Laundry sanitizer base only (for comparison) was introduced during the rinse cycle as follows:
      140 grams of Lysol Laundry Sanitizer (A) (base of composition according to the invention); or
      100 grams of Clorox Sanitizer (B) (base of composition according to the invention)
   Towels were machine dried: Normal setting for 45 minutes
   1 towel for each Panelist was evaluated; n=number of panelists
   The towels were evaluated using the Intensity Scale shown below
   Each towel was evaluated pre-rub and then rubbed 3× and evaluated post-rub
   The measurements were taken immediately after the wash+dry
III. Monitoring over time and temperature:
   Samples of bleach-free laundry sanitizer comprising microcapsules were stored at RT and at 40°° C.
   Machine Dried towels were obtained as above after 2, 4, 8, and 12 weeks of storage.
   The evaluation was carried out as described in step II.

Intensity scale: 0—No Fragrance; 1—Very weak; 2—Weak; 3—Fairly weak; 4—Relatively weak; 5—Moderate; 6—Relatively strong; 7—Fairly strong; 8—Strong; 9—Very strong; 10—Extremely strong.

The results of these evaluations are shown in Table 2.

TABLE 2
Pre-rub and post-rub values recorded on towels washed using bleach-free laundry sanitizer
according to the invention

| Slurry + sanitizer | initial | | 2 weeks | | 4 weeks | | 8 weeks | | 12 weeks | |
|---|---|---|---|---|---|---|---|---|---|---|
| base/sanitizer | Pre- | Post- | Pre- | Post- | Pre- | Post- | Pre- | Post- | Pre- | Post- |
| base | rub | rub | rub | rub | rub | rub | rub | rub | rub | rub |

Fragrance free Lysol Laundry Sanitizer (A)

| | | | | | | | | | | |
|---|---|---|---|---|---|---|---|---|---|---|
| A only | 0.8ª | 0.8ª | 1.0^{b} | 2.2^{b} | 1.1^{b} | 1.1^{b} | 1.1^{d} | 1.2^{d} | 1.2ª | 1.2ª |
| | | | 0.7^{b} | 0.8^{b} | 1.1^{b} | 1.3^{b} | 0.6^{d} | 1.1^{d} | 0.8ª | 1.5ª |
| 1.1^{m} | 4.0^{a} | 7.3^{a} | | | 2.3ª | 6.1ª | 1.7^{b} | 5.2^{b} | 2.0^{c} | 5.5^{c} |
| | | | | | 2.7ª | 3.5ª | 1.1^{b} | 1.3^{b} | 1.5^{c} | 2.4^{c} |
| 1.2^{m} | 4.1^{c} | 7.2^{c} | | | 2.3^{b} | 3.9^{b} | | | | |
| | | | | | 2.8^{b} | 3.2^{b} | | | | |
| 1.3^{m} | 3.8^{c} | 7.8^{c} | | | 4.1^{b} | 6.6^{b} | 2.6^{b} | 5.7^{b} | 3.8^{c} | 6.8^{c} |
| | | | | | 5.0^{b} | 7.2^{b} | 4.3^{b} | 6.4^{b} | 4.6^{c} | 6.5^{c} |
| 1.4ⁿ | 4.5ª | 7.8ª | 2.7^{b} | 5.2^{b} | 4.0^{b} | 5.2^{b} | 2.8^{d} | 4.6^{d} | 3.0ª | 4.8ª |
| | | | 2.3^{b} | 5.4^{b} | 2.9^{b} | 5.2^{b} | 2.0^{d} | 3.9^{d} | 2.2ª | 4.7ª |
| 1.5ⁿ | 3.6ª | 7.3ª | 4.6^{b} | 7.8^{b} | 4.9^{b} | 7.7^{b} | 4.1^{d} | 6.7^{d} | 4.9ª | 8.0^{a} |
| | | | 1.7^{b} | 5.3^{b} | 2.2^{b} | 4.1^{b} | 1.7^{d} | 4.1^{d} | 2.5ª | 5.5ª |

Clorox Laundry sanitizer (B)

| | | | | | | | | |
|---|---|---|---|---|---|---|---|---|
| B only | 2.4ª | 2.7^{a} | 1.5ª | 1.9ª | 1.9^{b} | 2.0^{b} | 2.0^{b} | 2.2^{b} |
| | | | 1.5ª | 2.0ª | 1.5^{b} | 1.7^{b} | 1.6^{b} | 1.9^{b} |
| 1.1^{m} | 3.7ª | 7.5ª | 2.7ª | 6.1ª | 2.9^{b} | 6.1^{b} | 2.4^{b} | 6.4^{b} |
| | | | 2.5ª | 5.8ª | 2.6^{b} | 4.0^{b} | 2.2^{b} | 2.4^{b} |
| 1.2^{m} | 4.3ª | 8.0ª | 2.1ª | 5.3ª | 2.2^{b} | 4.8^{b} | 2.7^{b} | 6.1^{b} |
| | | | 2.5ª | 5.7ª | 2.9^{b} | 5.2^{b} | 3.3^{b} | 4.8^{b} |
| 1.3^{m} | 4.2ª | 6.8ª | 3.6ª | 6.3ª | 4.2^{b} | 6.8^{b} | 2.9^{b} | 6.3^{b} |
| | | | 2.9ª | 5.9ª | 3.1^{b} | 5.4^{b} | 3.5^{b} | 5.7^{b} |
| 1.4ⁿ | 3.80 | 7.8^{c} | 3.9^{b} | 7.5^{b} | 4.0^{b} | 7.6^{b} | | |
| | | | 2.2^{b} | 4.0^{b} | 2.4^{b} | 4.3^{b} | | |
| 1.5ⁿ | 2.3^{c} | 7.30 | 3.6^{b} | 7.7^{b} | 3.6^{b} | 7.6^{b} | | |
| | | | 2.4^{b} | 5.4^{b} | 2.8^{b} | 5.3^{b} | | |

top row: RT; bottom row: 40° C.
^{a}n = 10;
^{b}n = 9;
^{c}n = 8;
^{d}n = 11 (n = number of panelists)
^{m}Fragrance Dose: Neat Oil Eq = 0.13%
ⁿFragrance Dose: Neat Oil Eq = 0.10%

As expected, none of the laundry sanitizer bases A or B showed any pre-rub or post-rub boost at any time or temperature (both pre-rub and post-rub values below or equal to 2.2).

All the microcapsules tested showed good performance in both sanitizer bases, over at least 8 weeks, some maintaining a post-rub boost even after 12 weeks, at both room temperature and 40° C. It can be observed that the melamine-formaldehyde microcapsules begin to lose some of the post-rub burst intensity at 8 weeks and deteriorate to no burst at 12 weeks when stored at 40° C.

Surprisingly, outstanding results were observed in both laundry sanitizer bases, even after 8 or 12 weeks, at both room temperature and at 40° C., for the laundry sanitizers comprising microcapsules of Examples 1.3 (polyurea-based capsules), 1.4 (hydrated polymer phase and polymeric stabilizer microcapsules) and 1.5 (microcapsules comprising a complex coacervate formed of at least one protein and at least one polysaccharide).

Most notably, the post-rub performance of the microcapsules of Example 1.5 remained fairly strong to strong over 12 weeks at room temperature in both laundry sanitizer bases. The microcapsules of Example 1.4 maintained their fairly strong to strong performance at room temperature in the Clorox Laundry sanitizer base (B) over at least 8 weeks.

Generally, as expected, the post-rub performance of most microcapsules at room temperature appears to be higher than at 40° C., in both laundry sanitizer bases, with the exception of the microcapsules of Example 1.3, which performed equally well at both temperatures in both laundry sanitizer bases, with less than about 20% loss of post-rub performance over 12 weeks.

1. A bleach-free laundry sanitizer composition comprising at least one microcapsule composition comprising a polymer encapsulating a benefit agent, wherein the benefit agent is encapsulated in core-shell microcapsules comprising a core and a shell surrounding the core.

2. The bleach-free laundry sanitizer composition according to claim 1, wherein the shell of the microcapsule comprises a melamine-formaldehyde polymer, an urea-formaldehyde polymer, a polyurea or polyurethane polymer, a polyamide, a polyacrylate, a polycarbonate, a polymeric stabilizer that is formed by combination of a polymeric surfactant with at least one aminosilane, a complex coacervate formed by cross-linking of at least one protein with a first cross-linking agent and at least one polysaccharide, or a hydrated polymer and a polymeric stabilizer formed by reaction of an aminosilane with a polyfunctional isocyanate.

3. The bleach-free laundry sanitizer composition according to claim 1, wherein the shell of the microcapsule comprises a polyurea polymer, a polymeric stabilizer that is formed by combination of a polymeric surfactant with at least one aminosilane, a complex coacervate formed by cross-linking of at least one protein with a first cross-linking agent and at least one polysaccharide, or a hydrated polymer and a polymeric stabilizer formed by reaction of an aminosilane with a polyfunctional isocyanate.

4. The bleach-free laundry sanitizer composition according to claim 1, wherein the benefit agent is selected from the group consisting of fragrance ingredients, bioactive agents, substrate enhancers, enzymes, dyes and pigments, and combinations thereof.

5. The bleach-free laundry sanitizer composition according to claim 4, wherein the level of fragrance in the bleach-free laundry sanitizer composition is between about 0.02% to about 0.40%.

6. The bleach-free laundry sanitizer composition according to claim 1, wherein the composition comprises quaternary ammonium compounds selected from the group consisting of dimethyl ammonium chloride of formula I, wherein R₁ and R₂ are independently a C₈-C₁₆ alkyl
NMe₂R₁R₂⁺Cl⁻ formula I;
alkyldimethylbenzylammonium chloride of formula II, wherein n=8, 10, 12, 14, 16, 18, and mixtures thereof 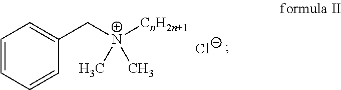
and mixtures thereof.

7. The bleach-free laundry sanitizer composition according to claim 6, wherein the level of quaternary ammonium compounds in the bleach-free laundry sanitizer composition is between about 1 wt % to about 4 wt %.

8. The bleach-free laundry sanitizer composition according to claim 1, wherein the pH of the bleach-free laundry sanitizer composition is between about 7 to about 11.

9. The bleach-free laundry sanitizer composition according to claim 1, further comprising a laundry care additive.

10. The bleach-free laundry sanitizer composition according to claim 4, wherein at least the fragrance ingredient is biodegradable.

11. The bleach-free laundry sanitizer composition according to claim 1, wherein at least the shell surrounding the core is biodegradable.

12. A method of making the bleach-free laundry sanitizer composition according to claim 1 comprising the step of mixing at least one microcapsule composition comprising a polymer encapsulating a benefit agent, wherein the benefit agent is encapsulated in core-shell microcapsules comprising a core and a shell surrounding the core, into a bleach-free laundry sanitizer base composition.

13. A method for improving the fragrance perception or enhancing the performance of a bleach-free laundry sanitizer composition, wherein the method comprises adding at least one microcapsule composition comprising a polymer encapsulating a benefit agent, wherein the benefit agent is encapsulated in core-shell microcapsules comprising a core and a shell surrounding the core to the bleach-free laundry sanitizer composition.

14. The bleach-free laundry sanitizer composition according to claim 4, wherein the benefit agent is a fragrance ingredient.

15. The bleach-free laundry sanitizer composition according to claim 9, wherein the laundry care additive is a laundry conditioner.
